(19) United States
(12) Patent Application Publication
(10) Pub. No.: US 2008/0068593 A1
(43) Pub. Date: Mar. 20, 2008

(54) METHOD AND APPARATUS FOR DETECTING DEFECTS

(76) Inventors: HIROYUKI NAKANO, Chigasaki (JP); Yasuhiro Yoshitake, Yokohama (JP); Toshihiko Nakata, Hiratsuka (JP); Taketo Ueno, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/853,050

(22) Filed: Sep. 11, 2007

(30) Foreign Application Priority Data
Sep. 13, 2006 (JP) 2006-247479

(51) Int. Cl. G01N 21/00

(52) U.S. Cl. 356/73

(57) ABSTRACT

A defect detecting apparatus for detecting defects on a substrate sample (wafer) having circuit patterns such as interconnections. The defect detecting apparatus is provided with stages that can be moved arbitrarily in each of the X, Y, Z, and θ directions in a state that the substrate sample is mounted thereon, an illumination optical system for illuminating the circuit patterns from one or plural directions, and a detection optical system for detecting reflection light, diffraction light, or scattered light coming from an inspection region being illuminated through almost the entire hemispherical surface having the substrate sample as the bottom surface. The NA (numerical aperture) thereby falls within a range of 0.7 to 1.0. Harmful defects or foreign substances can be detected so as to be separated from non-defects such as surface roughness of interconnections.

### BACKGROUND OF THE INVENTION

The present invention relates to a method and apparatus for detecting foreign substances or defects that occur during manufacture of LSIs or liquid crystal substrates.

Conventional techniques for detecting foreign substances or defects stuck to or generated in a semiconductor wafer or the like are ones using signals that are detected by plural optical systems and plural detectors. These techniques are disclosed in, for example, JP-T-2006-501470 (the symbol “JP-T” as used herein means a published Japanese translation of a PCT application), JP-T-2005-539225, JP-T-2002-519694, JP-A-6-94633, JP-A-6-242012, JP-A-5-332946, and “Multidetector Hemispherical Polarized Optical Scattering Instrument,” 1999 SPIE Proceedings 3784, pp. 304-313.

JP-T-2006-501470 describes a method for inspecting a semiconductor wafer, which is included in the background art of the invention. A system for dark-field-inspecting the surface of a sample such as a semiconductor wafer is disclosed which is configured in such a manner that a certain area of a sample surface is illuminated with a pulse-laser-beam-based high-power light irradiation source, plural detector arrays receive, in a dark-field collection mode, radiations scattered from the same area of the surface and resulting images are formed. The detector arrays are configured so as to collect radiations scattered from the surface in different angular ranges. The system can determine dark-field scattering patterns simultaneously as functions of the scattering angles for plural points on the surface by composing images produced by different detector arrays.

There is a statement to the effect that scattered radiations may be collected by using a single objective lens assembly having a large numerical aperture (NA) capable of directing scattered beams in different angular ranges to the respective arrays. Reference is made to a spatial filter technique. That is, this publication states that a scattered light collection angular range can be restricted by stopping scattered light for detection in a certain region, which is particularly useful in rejecting background diffraction light coming from repetitive feature portions of a patterned wafer. And this publication states that this spatial filter stops strong diffraction light produced by known diffraction patterns of feature portions on the wafer surface and, as is well known in this technical field, increases the sensitivity to defects of the system.

Reference is also made to a polarization analyzing technique. That is, this publication states that a rotatable polarizer is disposed in the path of a detection optical system to select a polarization direction of scattered light to be detected, and that the polarizer is useful in increasing the detection sensitivity by stopping background scattered light produced by rough surfaces and/or high-reflectance surface structures of an inspection subject surface.

JP-T-2005-539225 discloses a method for inspecting a semiconductor wafer, which is included in the background art of the invention. That is, a compact surface inspection optical head having a frame with two sets of ring-shaped openings is disclosed in which a first set of openings that surround the vicinity of a vertical line extending from an inspection subject surface is used for collecting scattered light that is useful in detecting microscraches caused by chemical mechanical polishing. The publication states that if the positions of these openings are selected so as to avoid scattered light and diffraction light coming from patterns, these openings are useful in detecting abnormalities on a patterned surface.

This publication states that a second set of openings that surround the inspection subject surface in a small elevation angle range collects radiations scattered by a surface that is inspected for detection of abnormalities on a patterned surface. The publication states that detectors are disposed in several regions having different azimuth angles so that output signals, saturated by pattern diffraction or scattering, of detectors are discarded and only non-saturated output signals of detectors are used for abnormality detection. The publication also states that a pair of large openings are formed at a double-dark-field position and can be used for detection of abnormalities on a non-patterned surface, and that scattered light passing through the two large openings can be collected by an objective lens or a fiber bundle.

It is considered that this technique can be used for detecting abnormalities on different kinds of surfaces including a surface of a patterned semiconductor wafer or the like having a memory array and logic circuits and a non-pattered surface of a bare wafer or the like as well as abnormalities, caused by chemical mechanical polishing, on a semiconductor wafer.

JP-T-2002-519694 discloses a method for inspecting a semiconductor wafer, which is included in the background part of the invention. That is, a semiconductor wafer surface inspection method and apparatus for detecting defects on a patterned semiconductor wafer surface, in particular, defects caused by presence of particles are disclosed in which individual pixels on a wafer is inspected, discrimination characteristics of the respective pixels that are defined by how they respond to a scanning light beam are collected, and defects on the semiconductor wafer are detected by determining which of categories “defective”, “non-defective,” and “suspicious” the discrimination characteristic of each pixel is classified into.

A conventional apparatus which is based on direct comparison between different dies is described as having the following drawbacks, for example: 1) it is relatively expensive in the case where it requires high mechanical accuracy, 2) the throughput is low, 3) it occupies a large area, 4) it requires a dedicated operator, 5) it is not suitable for in-line inspection (i.e., the apparatus operates for a wafer that is removed from a production line in advance) and hence is not suitable for process management or monitoring, and 6) it is an anisotropic apparatus (i.e., it is necessary that an object to be inspected be positioned very accurately. JP-T-2002-519694 states that the technique of this publication can solve these drawbacks.

JP-A-6-94633 discloses a method for inspecting a semiconductor wafer, which is included in the background art of the invention. That is, a method for detecting defects on a wafer is disclosed in which a semiconductor wafer is illuminated obliquely, a Fourier spectrum is measured by condensing light generated from an illumination region with a Fourier transform lens disposed over the semiconductor wafer and detecting the condensed light with a two-dimensional photoelectric conversion element array disposed on a Fourier transform plane, and the photodetecting region is disposed in a direction with longest diffraction beam intervals on the basis of the measurement result.

JP-A-6-242012 discloses a foreign substance detecting apparatus capable of properly detecting even faint light reflected and scattered by fine particles without being affected by background light, sensor shot noise, or the like. That is, the apparatus is characterized by comprising mounting means for mounting and fixing an inspection subject so that its entire surface can be scanned, illuminating means for illuminating the inspection subject, plural photodetecting means for detecting scattered reflection light coming from the inspection subject and outputting photodetection signals corresponding to photodetection intensities, threshold processing means for adding the photodetection signals together and comparing a resulting signal with a threshold value, and correlation computing means for comparing the individual photodetection signals with a reference signal stored in advance, the apparatus is further characterized in that the illuminating means emits light of a polarization component and each photodetecting means can detect both of a polarization component that is the same in polarization direction as the inspection light and a polarization component that is different in polarization direction from the inspection light. The publication states as follows. Whereas noise signals such as sensor shot noises occur randomly in time in each photodetecting means, when such defects as attached fine particles or wafer roughness on an inspection subject are illuminated, scattered reflection light is generated and detected simultaneously by the photodetecting means disposed in the respective directions. Therefore, if outputs of the respective photodetecting means are added together in a synchronized manner, signals generated by attached fine particles or the like are superimposed one on another to produce a large peak. On the other hand, sensor shot noises which occur randomly produce a small peak. Therefore, signals corresponding to defects on the inspection subject and noise signals can be discriminated from each other by comparing the magnitude of an addition signal with a prescribed threshold value. When a fine particle is illuminated with light of a particular polarization component, scattering patterns of a polarization component that is the same in polarization direction as the incident light and a polarization component that is different in polarization direction from the incident light have particular shapes irrespective of the particle diameter. Therefore, only attached fine particles can be discriminated more clearly by checking a magnitude relationship between output signals of each photodetecting means which separately detects a polarization component that is the same in polarization direction as incident light and a polarization component that is different in polarization direction from the incident light. This publication also discloses a method of detecting fine particles attached to a wafer surface by correlating each photodetection signal with data values of a scattered light intensity distribution obtained by a simulation or the like.

JP-A-5-332946 discloses a surface inspection apparatus having surface judging means for judging a surface state of an inspection subject. That is, the apparatus is provided with an illumination optical system for illuminating an inspection subject with laser light from a prescribed direction, first photoelectric conversion means disposed in a prescribed angular direction with respect to the inspection subject, for condensing light scattered by fine particles attached to the inspection subject and converting condensed light into a first electrical signal corresponding to its intensity, second photoelectric conversion means disposed above the inspection subject, for condensing light scattered by the inspection subject or the fine particles or both and converting condensed light into a second electrical signal corresponding to its intensity, and surface judging means for judging a surface state of the inspection subject on the basis of the first and second electrical signals supplied from the first and second photoelectric conversion means. In the first photoelectric conversion means, optical fiber bundles are disposed in such directions (angle α: 25°; fiber light condensing angle: ±9°) that the optical intensity is high in the distribution of light scattered by fine particles attached to an inspection subject and photoelectric converters are connected to the optical fiber bundles. In the second photoelectric conversion means, plural optical fibers are bundled so that their light incidence end faces form at least ¼ of a hemispherical surface (usually, the entire spherical surface excluding the first optical fiber bundles) and photoelectric converters are connected to those optical fibers. The surface judging means compares the level of the second electrical signal with a threshold level. Such data as sizes of the fine particles are collected on the basis of the first electrical signal if the level of the second electrical signal is higher.

With the above means, when laser light is applied to an inspection subject from the prescribed direction by the illumination optical system, the first photoelectric conversion means which is disposed in the directions in which the intensity of light scattered by fine particles attached to the inspection subject is high condenses scattered light and converts it into a first electrical signal corresponding to its intensity. Scattered light other than the condensed scattered light, that is, light scattered by the inspection subject or the fine particles or both is condensed by the second photoelectric conversion means which is disposed above the inspection subject and converted into a second electrical signal corresponding to its intensity. The surface judging means judges a surface state of the inspection subject on the basis of the first and second electrical signals.

“Multidetector Hemispherical Polarized Optical Scattering Instrument Scattering and Surface Roughness” discloses a method for discriminating surface roughness and defects on a semiconductor wafer from each other in the following manner. A semiconductor wafer is illuminated with laser light. Light coming from the semiconductor wafer is condensed by 28 condenser lenses that are arranged in a hemispherical surface having the wafer as the bottom surface, and only particular polarization components are extracted and converted into electrical signals by 28 sensors corresponding to the 28 condenser lenses, respectively. The electrical signals thus obtained are used selectively.

In the apparatus and the methods of the conventional techniques, only part of light beams that are generated in all directions over a semiconductor wafer is detected and those light beams are converted into electrical signals. Therefore, information in non-detected regions is lost. Therefore, when it becomes necessary to use information in a non-detected region, it is necessary to change the apparatus configuration or change the arrangement of the photodetecting system which should be movable and perform an inspection again. This means drawbacks that the apparatus configuration is complicated and an inspection takes long time.

### SUMMARY OF THE INVENTION

The present invention relates to a defect detecting method and apparatus which make it possible to discriminate defects using light that is detected through the almost entire hemispherical surface having a subject of processing as the bottom surface in detecting defects or foreign substances occurring on various patterns formed on the subject of processing so as to be discriminated from normal circuit patterns in manufacture of an LSI or a liquid crystal substrate.

The invention also relates to a defect detecting method and apparatus which make it possible to detect plural polarization components individually and simultaneously and cause defects to appear utilizing differences in polarization between defects and noise.

Both of the apparatus aspect and the method aspect of the invention are based on a technique of converting almost all light passing through a hemispherical surface having an inspection subject as the bottom surface into electrical signals for each of plural polarization components without changing the apparatus configuration and causing defects to appear using those electrical signals. Although this specification is directed to a patterned semiconductor wafer, the object of the invention is to detect defects on a semiconductor wafer and the invention can also be applied to a non-patterned semiconductor wafer.

The invention provides a defect detecting apparatus for detecting defects on a substrate sample (wafer) having circuit patterns such as interconnections, comprising stages that can be moved arbitrarily in each of the X, Y, Z, and θ directions in a state that the substrate sample is mounted thereon, an illumination optical system for illuminating the circuit patterns from one or plural directions, and a condensing optical system consisting of plural optical systems for detecting reflection light, diffraction light, or scattered light coming from an inspection region being illuminated through almost the entire hemispherical surface having the substrate sample as the bottom surface, that is, with the NA (numerical aperture) being in a range of 0.7 to 1.0, a polarization-separating optical system for separating each of condensed beams into plural polarization components, plural photodetectors for detecting the plural polarization components and converting them into electrical signals, a storage device for storing the electrical signals, and defect detecting means for detecting defects by discriminating the defects from noise by processing the electrical signals.

According to the invention, information of plural polarization components detected through an area whose NA is approximately equal to 1.0 is converted into electrical signals and stored. Then, light generated by defects and foreign substances can be discriminated from noise light that is generated by non-defects such as edge roughness and surface roughness by using the information stored. The sensitivity of detection of defects and foreign substances can thus be increased.

These and other objects, features, and advantages of the invention will be apparent from the following more particular description of preferred embodiments of the invention, as illustrated in the accompanying drawings.

### BRIEF DESCRIPTION OF THE DRAWINGS

FIG. 1 shows the configuration of an apparatus according to a first embodiment of the present invention;

FIG. 2 is a flowchart outlining the operation of the apparatus according to the first embodiment of the invention;

FIG. 3 shows an optical system which epi-illuminates a wafer in the first embodiment of the invention;

FIG. 4 shows an optical system which illuminates a wafer obliquely in the first embodiment of the invention;

FIGS. 5(a) and 5(b) are a front view and a side view, respectively, of the epi-illumination optical system in the first embodiment of the invention, and FIG. 5(c) shows the shape of an illumination region formed on the wafer by the epi-illumination in the first embodiment of the invention;

FIGS. 6(a) and 6(b) are a plan view and a side view, respectively, of the oblique illumination optical system in the first embodiment of the invention, and FIG. 6(c) shows the shape of an illumination region formed on the wafer by the oblique illumination in the first embodiment of the invention;

FIG. 7 shows another epi-illumination optical system in the first embodiment of the invention;

FIGS. 8(a) and 8(b) are a front view and a side view, respectively, of the epi-illumination optical system of FIG. 7, and FIG. 8(c) shows the shape of an illumination region formed on the wafer by the epi-illumination optical system FIG. 7;

FIG. 9 shows how light is condensed by a condenser lens in the first embodiment of the invention;

FIG. 10(a) shows visual fields of cell lenses having the same elevation angle and different azimuth angles and FIG. 10(b) shows visual fields of cell lenses having the same azimuth angle and different elevation angles in the first embodiment of the invention;

FIG. 11(a) shows an illumination region s2 that is common to detection visual fields of a fly-eye lens 300 in the case of epi-illumination and FIG. 11(b) shows an illumination region s3 that is common to detection visual fields of the fly-eye lens 300 in the case of oblique illumination in the first embodiment of the invention;

FIG. 12 shows a modification of the illumination optical system in the first embodiment of the invention;

FIG. 13 shows how light is condensed by a fiber array in the first embodiment of the invention;

FIG. 14 shows how light is received by an array of optical fibers, the arrangement of the optical fibers is changed, the optical fibers are divided into plural fiber bundles, and exit beams of the fiber bundles are condensed onto and detected by photodetectors with polarization selection in the first embodiment of the invention;

FIG. 15 shows how light is received by an array of optical fibers, the arrangement of the optical fibers is changed, the optical fibers are divided into plural fiber bundles, and exit beams of the fiber bundles are detected by photodetectors with polarization selection in the first embodiment of the invention;

FIG. 16 shows how light is received by an array of optical fibers, the arrangement of the optical fibers is changed, and exit beams of the optical fibers are detected by photodetectors with polarization selection in the first embodiment of the invention;

FIG. 17 shows how a wafer is scanned in the first embodiment of the invention;

FIG. 18 shows illumination regions on the wafer in the first embodiment of the invention;

FIG. 19(a) is a sectional view showing how signals are obtained through a hemispherical surface 500, and FIG. 19(b) shows how the hemispherical surface 500 is projected on to a plane (circle) 704;

FIG. 20 shows a circuit configuration for acquiring polarization-separated pupil images in the first embodiment of the invention;

FIG. 21 shows a process of judging coordinates, kinds, and sizes of defects using a polarization-separated pupil image in the first embodiment of the invention;

FIG. 22 is a perspective view of an optical system in which the wafer is illuminated through a hole that is formed in a fly-eye lens;

FIG. 23(a) shows a modification of wafer scanning and FIG. 23(b) shows illumination regions on the wafer in the first embodiment of the invention;

FIG. 24 shows the configuration of an apparatus according to a second embodiment of the invention;

FIG. 25 is a perspective view of part of the apparatus according to the second embodiment of the invention and shows a relationship between wafer scanning and oblique illumination;

FIG. 26 is a perspective view of part of the apparatus according to the second embodiment of the invention and shows a relationship between wafer scanning and epi-illumination;

FIG. 27(a) shows a manner of wafer scanning and an illumination region on the wafer and FIG. 27(b) is an enlarged view of part of the surface of the wafer showing an illumination region on a chip in the second embodiment of the invention;

FIG. 28 shows a relationship between wafer scanning and illumination regions s3 occurring at plural time points in the second embodiment of the invention;

FIG. 29(a) shows a state that a periodic pattern is illuminated from a direction that is perpendicular to it, FIG. 29(b) shows diffraction light generated by the periodic pattern, and FIG. 29(c) shows a distribution of the diffraction light at a pupil position in the second embodiment of the invention;

FIG. 30(a) shows a state that the periodic pattern is illuminated from a direction that is oblique to it, FIG. 30(b) shows diffraction light generated by the periodic pattern, and FIG. 30(c) shows a distribution of the diffraction light at the pupil position in the second embodiment of the invention;

FIG. 31(a) shows a state that another periodic pattern is illuminated from a direction that is oblique to it, FIG. 31(b) shows diffraction light generated by the periodic pattern, and FIG. 31(c) shows a distribution of the diffraction light at the pupil position in the second embodiment of the invention;

FIG. 32(a) shows a state that patterns having different pitches are illuminated from a direction that is oblique to the pattern arrangement direction and FIG. 32(b) shows a distribution, at the pupil position, of diffraction light generated by the patterns having the different pitches in the second embodiment of the invention;

FIG. 33(a) shows a state that a random pattern is illuminated, FIG. 33(b) shows diffraction light generated by the random pattern, and FIG. 33(c) shows a distribution of the diffraction light at the pupil position in the second embodiment of the invention;

FIG. 34 shows a pattern, a far-field pattern (i.e., a distribution at the pupil position), pattern elimination by spatial filtering (frequency filtering), and pattern recognition in the second embodiment of the invention;

FIG. 35 shows a method for selecting sensor outputs to be used on the basis of a periodicity recognition result of the distribution of diffraction light at the pupil position in the second embodiment of the invention;

FIG. 36(a) shows a temporal variation of an addition result of all signals of a single signal-selected pupil image, FIG. 36(b) shows a temporal variation of an addition signal in which a threshold value is set for signal levels corresponding to a random pattern area, and FIG. 36(c) shows a temporal variation of an addition signal in which a threshold value is set for signal levels corresponding to a periodic pattern area;

FIG. 37(a) is a graph showing a relationship between the output value of each detector and the frequency and explaining a method for setting a threshold value in the case of a periodic pattern, FIG. 37(b) is a graph showing a relationship between the output value of each detector and the frequency and explaining a method for setting a threshold value in the case of a random pattern, FIG. 37(c) is a graph showing a relationship between the output value of each detector and the frequency and explaining a method for setting a threshold value in the case where a distribution specific to a regular pattern is found in a distribution specific to a random pattern, and FIG. 37(d) is a graph showing unprocessed signals and processed signals;

FIG. 38 shows a circuit configuration for acquiring polarization-separated pupil images, determining sensor outputs to be used after recognizing periodicity of the pupil images, and acquiring sensor-selected pupil images in the second embodiment of the invention;

FIG. 39 shows a process of judging coordinates, kinds, and sizes of defects by determining threshold values from sensor-selected pupil images in the second embodiment of the invention;

FIG. 40(a) shows a case that a recess defect is illuminated from a direction having a small elevation angle (i.e., having a large angle with respect to the normal to the surface of a wafer W), FIG. 40(b) shows a case that a recess defect is illuminated from a direction having a large elevation angle (i.e., having a small angle with respect to the normal to the surface of a wafer W), FIG. 40(c) shows a case that a projection defect is illuminated from a direction having a small elevation angle (i.e., having a large angle with respect to the normal to the surface of a wafer W), and FIG. 40(b) shows a case that a projection defect is illuminated from a direction having a elevation angle (i.e., having a small angle with respect to the normal to the surface of a wafer W);

FIG. 41 is a list showing how the intensity of scattered light coming from a scratch or a foreign substance varies with the illumination angle in the first embodiment of the invention;

FIG. 42 shows how beams are applied to the surface of an inspection subject (wafer) from different illumination directions (i.e., at different elevation angles) in the first embodiment of the invention;

FIG. 43 shows how defects can be classified by calculating the ratio between signals obtained through illumination at different elevation angles in the first embodiment of the invention;

FIG. 44 is a graph showing that the transmittance depends on the polarization of illumination light (s-polarization or p-polarization);

FIG. 45 is a list showing how light generated by a defect on a transparent film and light generated by a defect inside a transparent film are different from each other in intensity when they are illuminated with each of differently polarized beams in the first embodiment of the invention;

FIG. 46 shows how defects on a transparent film and defects inside a transparent film are discriminated from each other for classification by calculating the ratio between signals obtained through illumination with differently polarized beams in the first embodiment of the invention;

FIG. 47 shows a method for applying beams having different wavelengths to the surface of an inspection subject in the first embodiment of the invention;

FIG. 48 shows how scattered light having different wavelengths generated through illumination with beams having the different wavelengths is separated into beams having the different wavelengths and each of them is polarization-selected, and detected by a photodetector in the first embodiment of the invention;

FIG. 49 shows the configuration of a conventional defect detecting apparatus; and

FIG. 50 is a flowchart outlining the operation of the conventional defect detecting apparatus.

### DESCRIPTION OF THE PREFERRED EMBODIMENTS

Embodiments of the present invention will be hereinafter described with reference to the drawings.

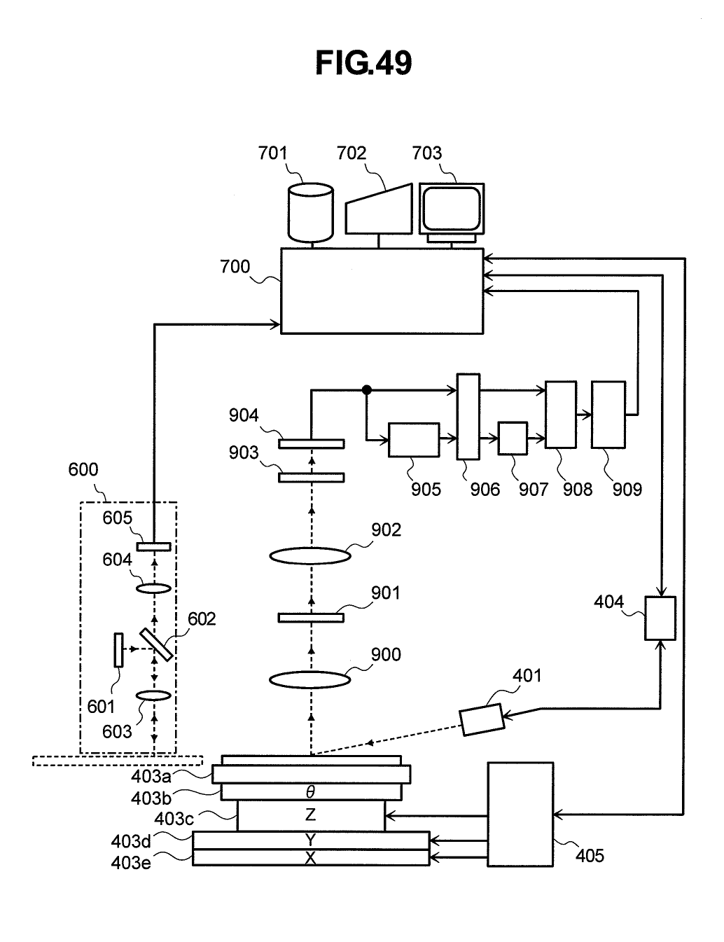

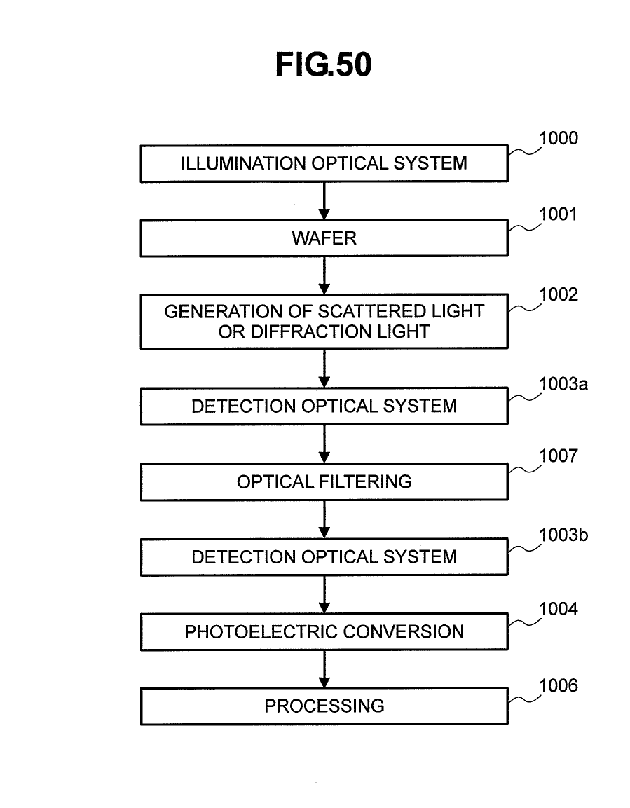

First, a conventional technique will be described with reference to FIGS. 49 and 50. As shown in FIG. 49, a semiconductor wafer W as an inspection subject is held by a wafer chuck 403a. The position of the semiconductor wafer W in the θ direction is adjusted by a θ stage 403b and its position in the height direction is adjusted by a Z stage 403c. The semiconductor wafer W is scanned two-dimensionally by means of a Y stage 403d and an X stage 403e. These stages are controlled by a stage controller 405. The semiconductor wafer W is illuminated with laser light emitted from a laser light source 401, which is driven by a laser controller 404. Scattered light coming from a defect or a pattern on the semiconductor wafer W is condensed by an objective lens 900. Diffraction light coming from a periodic pattern is imaged at a rear focal position (Fourier transform plane) of the objective lens 900. Therefore, the diffraction light coming from the periodic pattern can be stopped by a spatial filter 901. The scattered light coming from the defect or pattern is imaged on a sensor 904 by an imaging lens 902. The sensor 904 converts the light into an electrical signal.

The semiconductor wafer W is scanned by means of the Y stage 403d and the X stage 403e, whereby a scattering image of the entire surface of the semiconductor wafer W is acquired. A comparison circuit 906 compares an inspection image delayed by a delay circuit 905 with a reference image that is a detection result of the same region of an adjacent chip, and a defect or a foreign substance is detected on the basis of a comparison result. For example, a difference image between detection images of the same region of adjoining chips is calculated and binarized. A binarization threshold value is determined by a threshold value circuit 907. A defect judgment circuit 908 judges that a signal larger than the binarization threshold value corresponds to a defect.

As for a signal that has been judged as corresponding to a defect, the defect is classified into one of plural kinds by a classification circuit 909 on the basis of the detection image. The defect judgment result of the defect judgment circuit 908 and the classification result of the classification circuit 909 are sent to a computer 700 and recorded therein together with defect coordinates. The results recorded in the computer 700 are stored in a storage device 701, output to an external computer, a printer, or an external storage device through an output device 702, or displayed on the display screen of a display device 703.

Defects can be observed through a defect review device 600. This is done in the following manner. A defect to be observed on the wafer W is placed on the optical axis of an objective lens 603 by controlling the stage controller 405 with the computer 700 on the basis of the position information of the defect on the wafer W. In this state, light emitted from a light source 601 (laser light source or lamp light source) shines on a half mirror 602 and part of the light is reflected by the half mirror 602 and illuminates the wafer W via the objective lens 603. Reflection light coming from the illuminated wafer W passes through the objective lens 603 and shines on the half mirror 602. Part of the reflection light enters an imaging lens 604 and forms an optical image on an imaging sensor 605. The optical image is detected by the imaging sensor 605 and converted into an electrical signal, which is input to the computer 700 and subjected to image processing there. An image in the visual field of the objective lens 603 is thus obtained and displayed on the display screen of the display device 703.

FIG. 50 is a simplified expression of the operation of the above prior art apparatus. A semiconductor wafer W is illuminated by an illumination optical system (step 1000). Generated scattered light or diffraction light (step 1002) is detected by a detection optical system (step 1003a), subjected to optical filtering (step 1007), detected by another detection optical system (step 1003b), and converted by a photoelectric converter (sensor) into an electrical signal (step 1004), which is subjected to defect judgment etc. in a processing circuit (step 1006). In this method, when light is detected optically, only part of light passing through a hemispherical surface having the inspection subject as the bottom surface is detected. Therefore, when it becomes necessary to use light that passes through a non-detected region, work of, for example, changing the apparatus configuration needs to be performed.

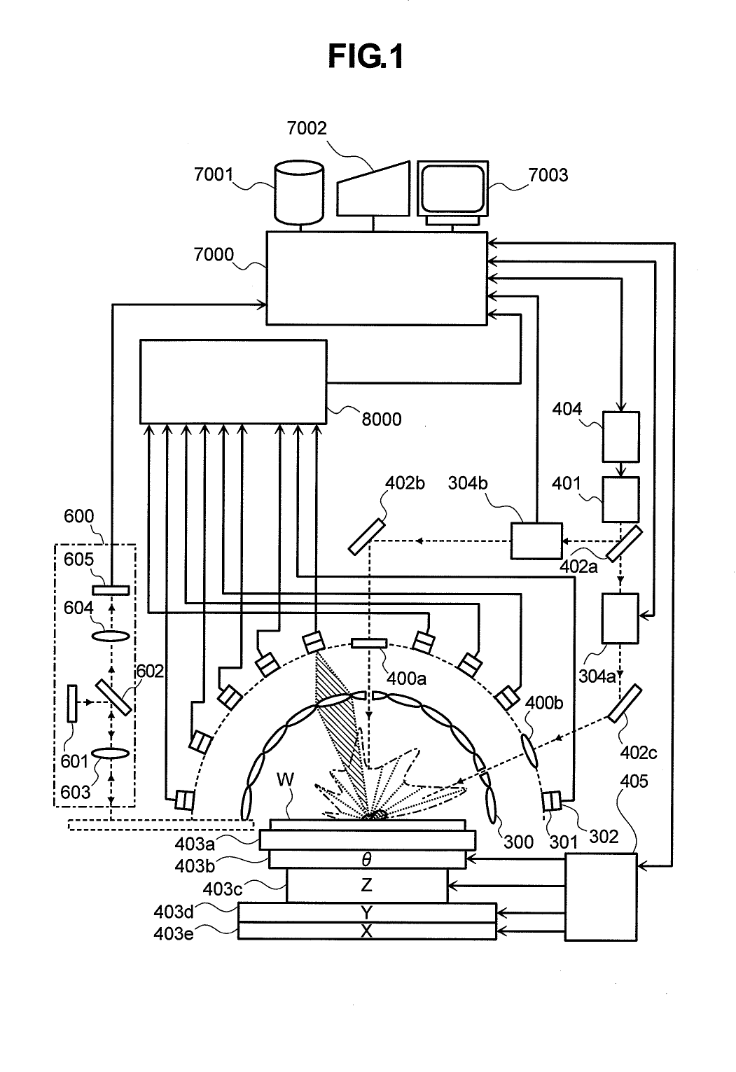

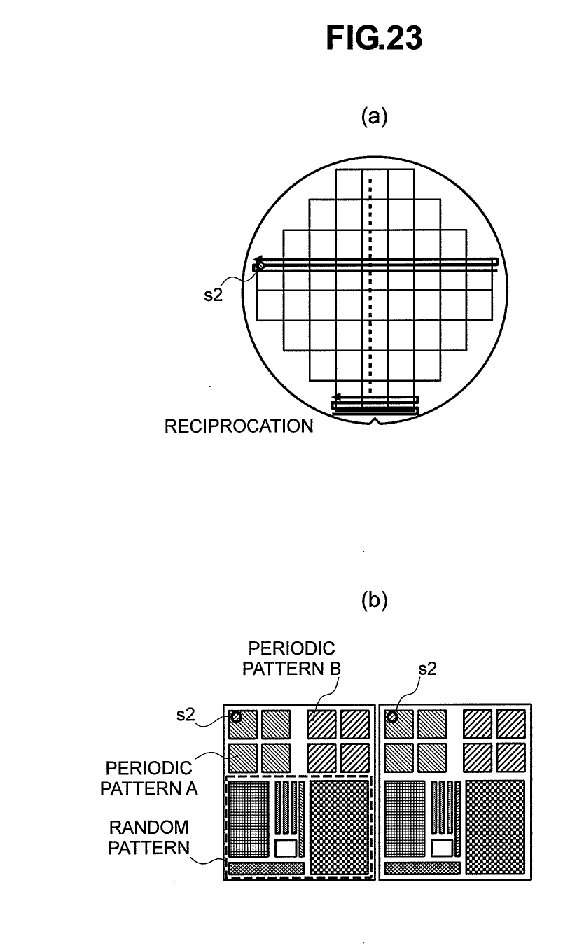

Next, a first embodiment of the invention will be described with reference to FIGS. 1-23. The following description will be directed to detection of defects on a semiconductor wafer.

First, FIG. 1 shows an exemplary apparatus for detecting defects on a semiconductor wafer. As shown in FIG. 1, the apparatus is composed of a laser light source 401 for emitting laser light, a laser controller 404 for driving the laser light source 401, plural condenser lenses 300 for condensing scattered light coming from an inspection subject (semiconductor wafer) W and defects, 4-segmented polarizing plates 301 each for dividing scattered light detected by the corresponding condenser lens 300 into four polarization components, 4-segmented photodetectors 302 each for detecting the four respective polarization components, a signal processing section 8000, a computer 7000, a storage device 7001, an output device 7002, a display device 7003, a wafer chuck 403a, a θ stage 403b, a Z stage 403c, a Y stage 403d and an X stage 403e for scanning the inspection subject W two-dimensionally, a stage controller 405, and a review microscope 600.

Next, the operation will be described. Polarized laser light emitted from the laser light source 401 is split into two parts by a mirror 402a. One of the split beams (polarized laser light) is subjected to light quantity adjustment in an attenuator 304b and applied to the wafer W from a direction that is approximately parallel with the normal to the wafer W via a mirror 402b and a cylindrical lens 400a. The other split beam (polarized laser light) produced by the mirror 402a is subjected to light quantity adjustment in an attenuator 304a and applied to the wafer W from a direction having a certain elevation angle with respect to the surface of the wafer W via a mirror 402c and a lens 400b. Reflection light, diffraction light, and scattered light generated by the illumination beams are condensed by the plural condenser lenses 300 which are disposed in a hemispherical surface having the wafer W as the bottom surface. Each condensed beam is divided into four polarization components as it passes through a 4-segmented polarizing plate 301 which corresponds to the condenser lens 300, and the four polarization components are detected by the corresponding 4-segmented photodetector 302 individually.

Signals produced by the 4-segmented photodetectors 302 through photoelectric conversion are sent to the signal processing section 8000, where they are subjected to A/D conversion and other processing. Resulting signals are sent to the computer 7000, where they are subjected to defect judgment, defect classification, defect size calculation, and other processing. The wafer W is fixed on the wafer check 403a. The wafer check 403a is configured so that its positions in the rotation direction and the height direction can be adjusted by the θ stage 403b and the Z stage 403c. The Z stage 403c is mounted on the combination of the Y stage 403d and the X stage 403e. Detection results can be obtained as a two-dimensional image by detecting scattered light coming from the wafer W while moving the Y stage 403d and the X stage 403e. The results thus obtained can be stored in the storage device 7001, output to the outside through the output device 7002, or displayed on the display device 7003.

The laser light source 401 may be a gas laser such as an Ar laser, a solid-state laser such as a semiconductor laser or a YAG laser, or a surface-emission laser. The wavelength range is a near infrared range or a visible range or even a UV range, a DUV range, or an EUV range. As for the method for selecting the laser light source 401, to increase the defect detection sensitivity, it is advantageous to use an illumination light source that operates in a shorter wavelength range. In this point of view, the use of a YAG laser, an Ar laser, or a UV laser is appropriate. To realize a small, inexpensive apparatus, the use of a semiconductor laser is appropriate. As for the oscillation mode, either a CW laser or a pulsed laser may be used. In this manner, a light source that is most suitable for the purpose may be selected as the laser light source 401.

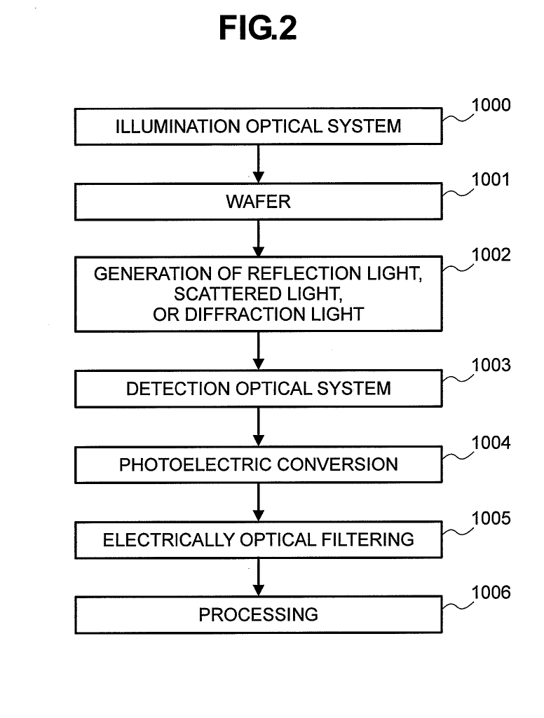

FIG. 2 shows a procedure for detecting defects on a wafer W using the above-configured apparatus. First, the wafer W is illuminated with the illumination optical system (step 1000). The wafer W is moved as the Y stage 403d and the X stage 403e are moved horizontally (step 1001). Reflection light, scattered light, or diffraction light is generated from a pattern or a defect on the wafer W (step 1002) which is moving while being illuminated, condensed by the detection optical system having the plural condenser lenses 300 which are disposed in the hemispherical surface (step 1003), and separated into four polarization components as they pass through the 4-segmented polarizing plates 301. The four polarization components produced by each 4-segmented polarizing plates 301 are detected and photoelectrically converted by the corresponding 4-segmented photodetector 302 (step 1004). Resulting electrical signals are subjected to electrical by optical filtering (step 1005), and defects are detected through signal processing (step 1006).

Part of the detected defects is observed in detail with the review microscope 600.

The review microscope 600, which is a known, general microscope, is composed of a light source 601 for illuminating the wafer W, a half mirror 602 for separating an illumination optical path and a detection optical path from each other, an objective lens 603 for condensing scattered light coming from a defect, an imaging lens 604 for imaging the scattered light condensed by the objective lens 603 onto an imaging sensor 605, and the imaging sensor 605.

Next, the operation of defect review will be described. A defect to be observed on the wafer W is placed on the optical axis of the objective lens 603 by controlling the stage controller 405 with the computer 7000 on the basis of the position information of the defect on the wafer W that was detected according to the procedure of FIG. 2. In this state, light emitted from the light source 601 (laser light source or lamp light source) shines on the half mirror 602 and part of the light is reflected by the half mirror 602 and illuminates the wafer W via the objective lens 603. Reflection light coming from the illuminated wafer W passes through the objective lens 603 and shines on the half mirror 602. Part of the reflection light enters the imaging lens 604 and forms an optical image on the imaging sensor 605. The optical image is detected and converted into an electrical signal by the imaging sensor 605. The electrical signal is input to the computer 7000 and subjected to image processing. An image in the visual field of the objective lens 603 is thus obtained and displayed on the display screen of the display device 7003.

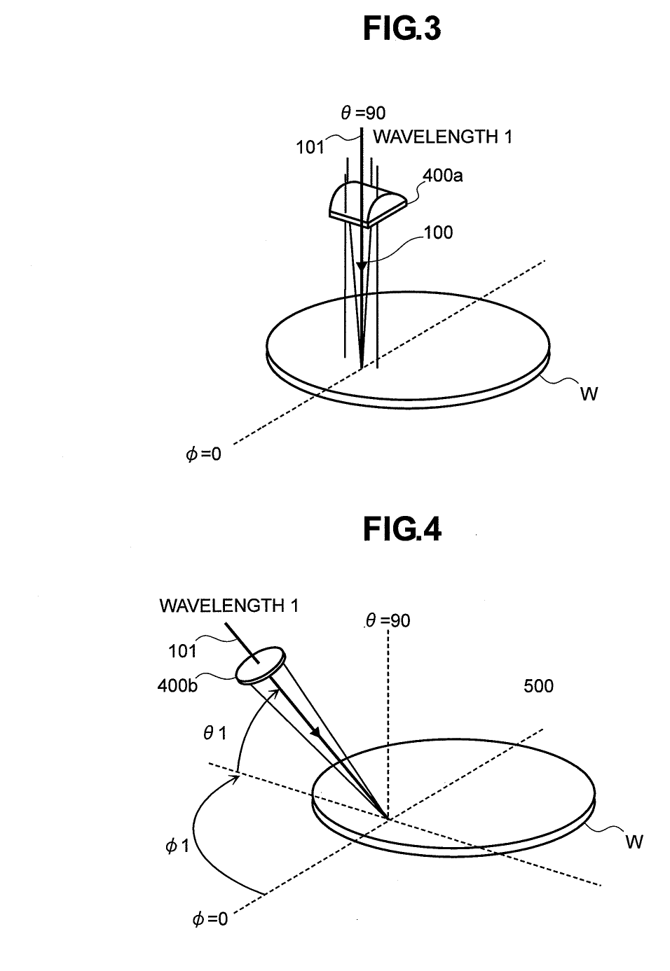

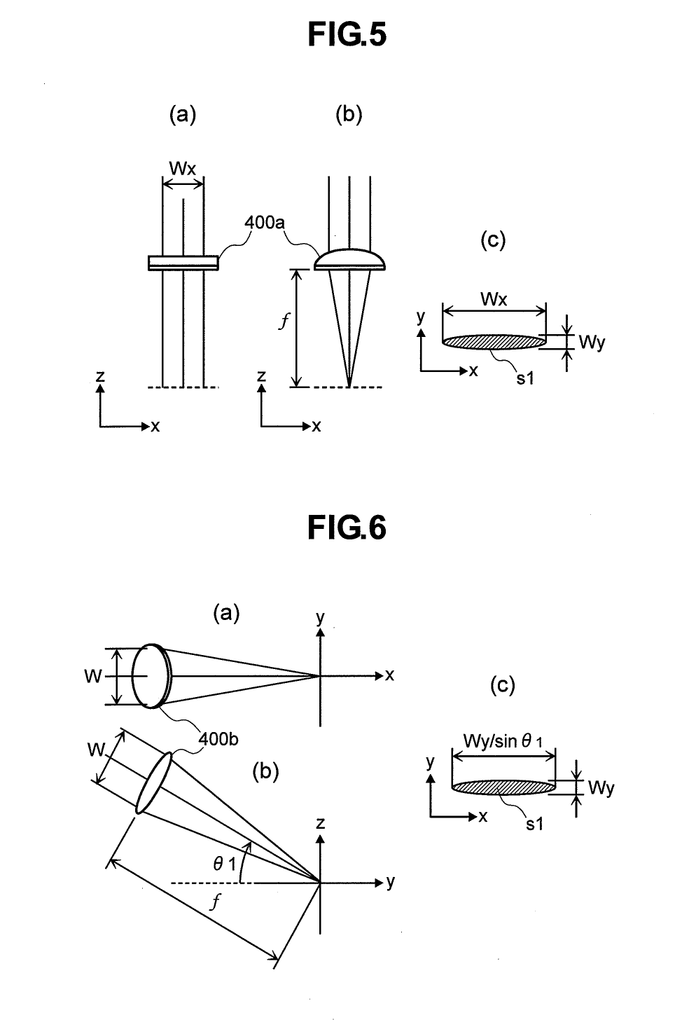

Next, the manner of illumination will be described with reference to FIGS. 3-8 and 12. An optical system shown in FIG. 3 is configured in such a manner that light is applied to the wafer W through a cylindrical lens 400a from the direction that is perpendicular to the wafer W (i.e., parallel with the normal to the wafer W). As shown in FIGS. 5(a) and 5(b), the optical system is adjusted so that the wafer W is distant from the cylindrical lens 400a by its focal length f. As shown in FIG. 5(c), a linear region s1 on the wafer W can be illuminated that measures Wx in the X direction and Wy in the Y direction, where Wx is equal to the diameter of a beam 101 incident on the cylindrical lens 400a.

As shown in FIG. 4, the wafer W can also be illuminated from an arbitrary direction which is determined by an arbitrary azimuth angle φ1 and an arbitrary elevation angle θ1. The optical system of FIG. 4 is configured in such a manner that light is applied to the wafer W through a spherical lens 400b. As shown in FIGS. 6(a)-6(c), the optical system is adjusted so that the wafer W is distant from the spherical lens 400b by its focal length f. As shown in FIGS. 6(a) and 6(b), a beam 101 illuminates the wafer W from the -X direction at the elevation angle θ1. As shown in FIG. 6(c), a linear region s1 on the wafer W can be illuminated that measures W_{y}/sin θ₁ in the X direction and W_{y} in the Y direction (W: the diameter of the beam 101 incident on the spherical lens 400b).

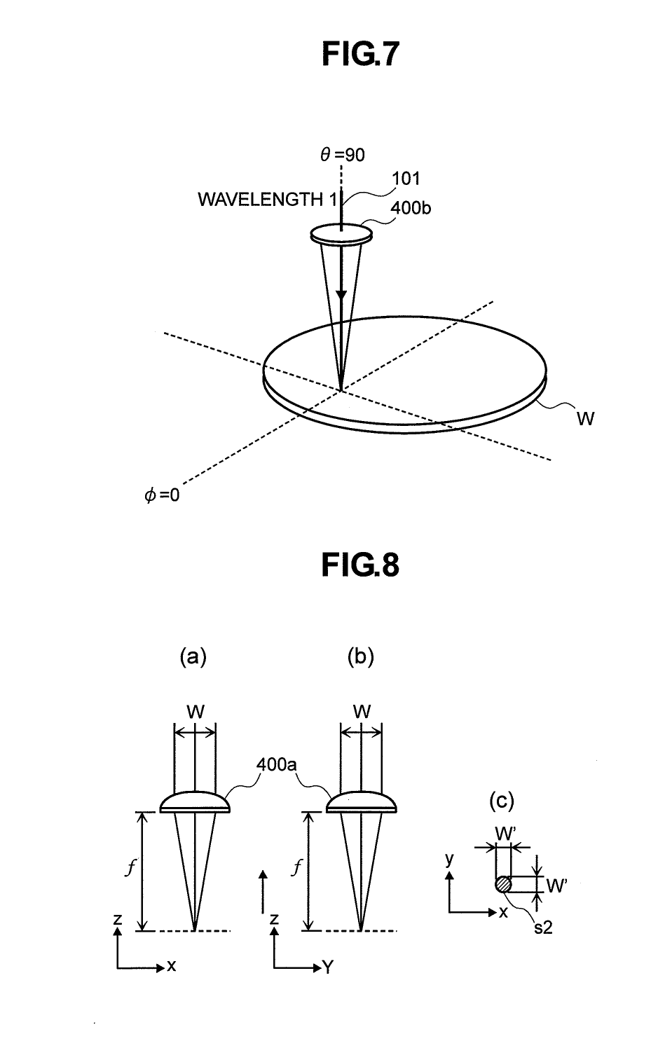

To illuminate the wafer W with a small spot size, as shown in FIG. 7, it is appropriate to employ epi-illumination using a spherical lens 400b so that an elongated spot is not formed on the wafer W. More specifically, as shown in FIGS. 8(a) and 8(b), the optical system is adjusted so that illumination light is focused at one point on the wafer W in either of a front view and a side view, the wafer W being distant from the spherical lens 400b by its focal length f. As shown in FIG. 8(c), a circular region s2 having a diameter W′ on the wafer W can be illuminated.

In the case of the oblique illumination shown in FIGS. 6(a) and 6(b), an elongated, elliptical spot is formed on the wafer W as shown in FIG. 6(c) though the spherical lens 400b focuses a beam into a circular spot on a plane that is perpendicular to the optical axis. Therefore, to perform epi-illumination and oblique illumination simultaneously, so that reflection light, scattered light, or diffraction light is generated from the same region by the two kinds of illumination, it is desirable that an elliptical spot as shown in FIG. 5(c) be formed by the epi-illumination by using the cylindrical lens 400a (see FIGS. 5(a) and 5(b)). Although in this embodiment the wafer W is illuminated after illumination light is condensed, parallel illumination light may be employed. If it is necessary to increase the light quantity per unit area on the wafer W, an appropriate measure is to increase the output power of the laser light source 401 or to narrow the illumination region.

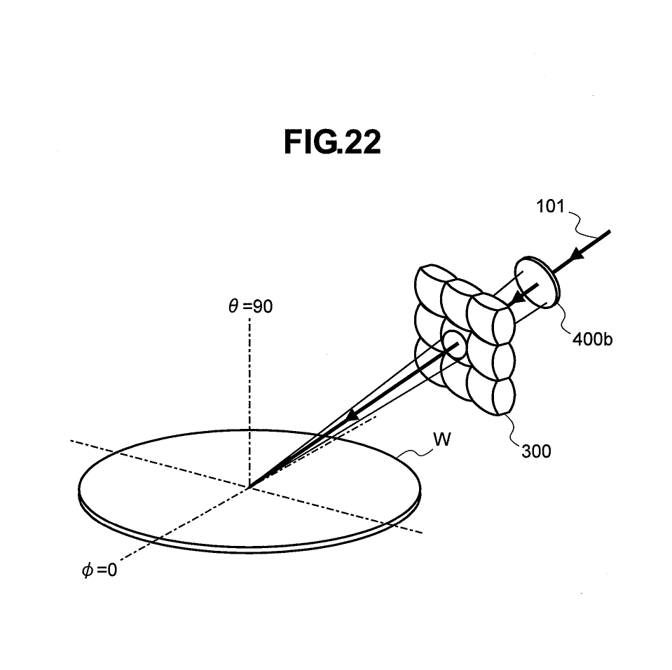

Incidentally, to illuminate the wafer W by the laser light source 401, a space for passage of illumination light needs to be formed in a portion of the fly-eye lens 300 which covers the entire hemispherical surface having the wafer W as the bottom surface. For example, as shown in FIG. 22, a space may be formed in a portion 3001 of the fly-eye lens 300. Alternatively, as shown in FIG. 12, illumination light may be condensed onto the wafer W through the spherical lens 400b and one cell lens of the fly-eye lens 300.

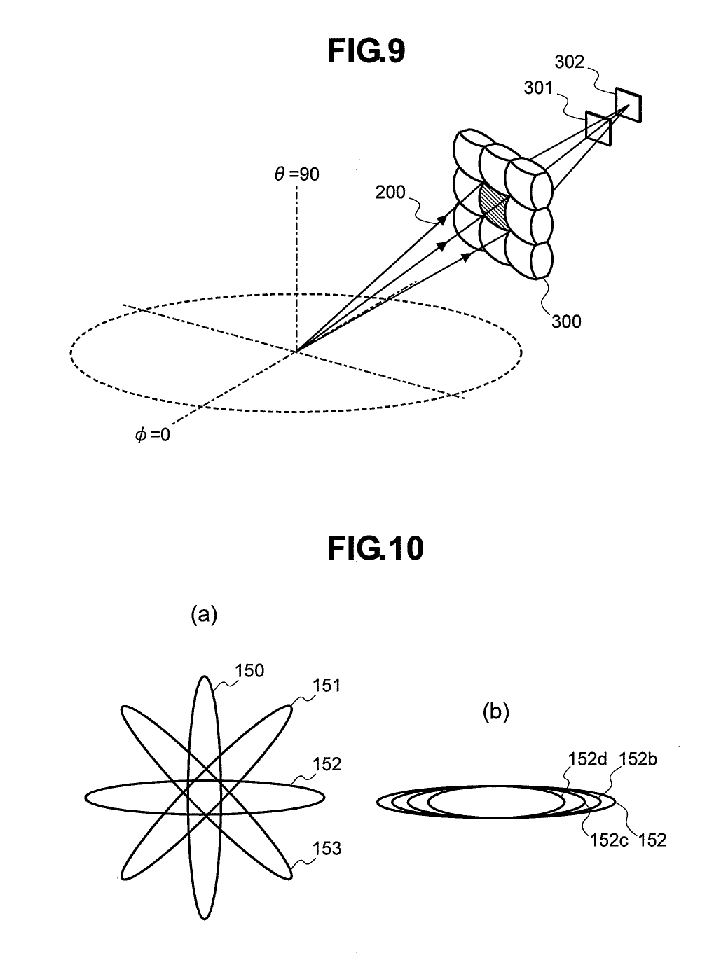

Next, a method for detecting light generated from an illumination region on the wafer W will be described with reference to FIG. 9. One object of the invention is to detect light through the almost entire hemispherical surface having the wafer W as the bottom surface. Therefore, one appropriate method is to lay a fly-eye lens 300 hemispherically. As shown in FIG. 9, scattered light 200 condensed by one cell lens of the fly-eye lens 300 is divided into four polarization components (having four polarization directions that are deviated from each other by 45° or 90°; indicated by symbol 301a or 301b in FIG. 48) by the 4-segmented polarizing plate 301. Put strictly, this is equivalent to a method that beams scattered in four different directions are detected as different polarization components. However, since the detection solid angle of each cell lens of the fly-eye lens 300 is small, it can be said, in view of the object of the invention, that this is equivalent to a method that a scattered beam traveling approximately in one direction is detected so as to be divided into four polarization components. The four polarization components are converted into different electrical signals by the 4-segmented photodetector 302 (denoted by symbol 302a or 302b in FIG. 48).

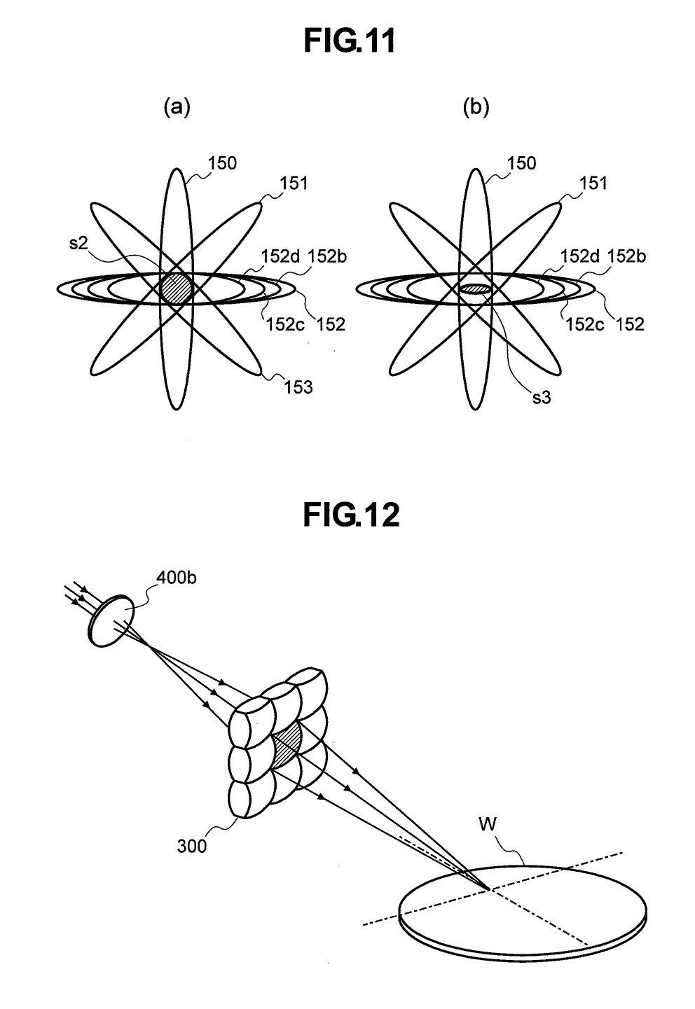

The visual field of each cell lens of the fly-eye lens 300 will be described here with reference to FIGS. 10(a) and 10(b). FIG. 10(a) shows visual fields 150-153 of cell lenses having the same elevation angle and different azimuth angles. Although the visual fields 150-153 have the same shape, they extend in the different directions on the wafer W. FIG. 10(b) shows visual fields 152 and 152b-152d of cell lenses having the same azimuth angle and different elevation angles. Although the visual fields 152 and 152b-152d extend the same direction, they are different in size on the wafer W. Therefore, to collect beams coming from the same region on the wafer W, it is appropriate to design the apparatus so that an illumination region s2 (see FIG. 11(a); epi-illumination) or s3 (see FIG. 11(b); oblique illumination) is common to all the visual fields, corresponding to the combinations of an azimuth angle and an elevation angle, of the fly-eye lens 300. This means that the spatial resolution of the detection is determined by the spot size of illumination light. Although not shown in any drawing, the apparatus may be configured in such a manner that the detection optical system is designed so that a point that is conjugate with the surface of the wafer W is located in the detection optical system and that the visual fields of the cell lenses of the fly-eye lens 300 are made to coincide with each other by a stop that is disposed at the conjugate point.

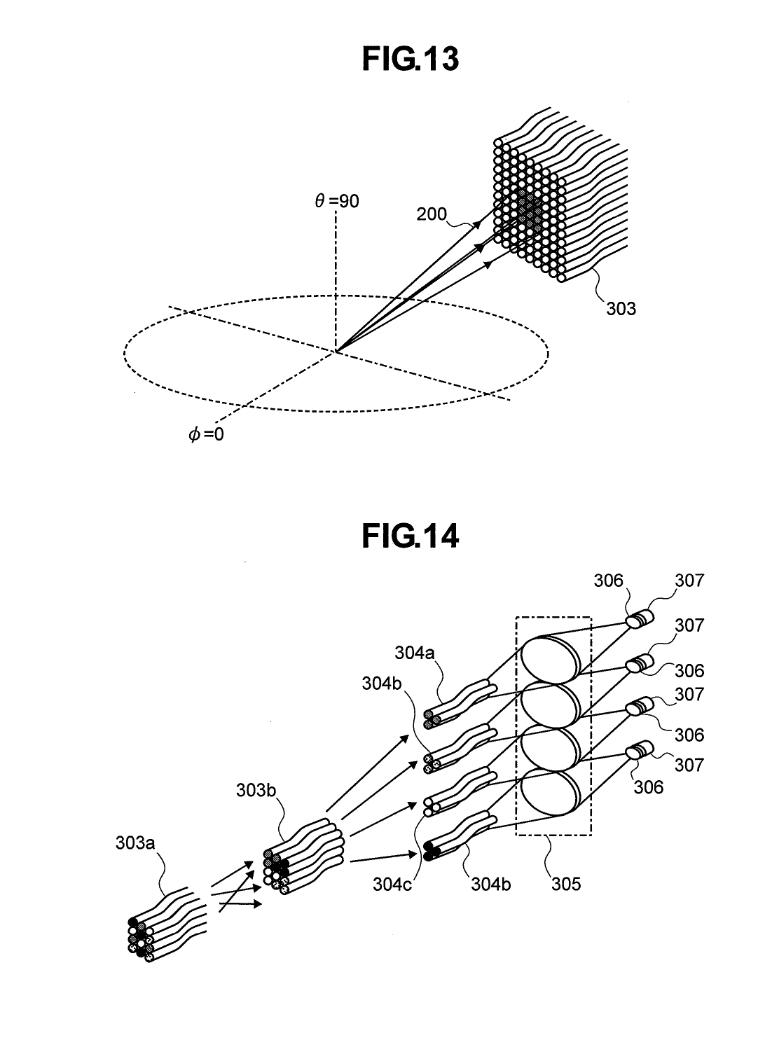

The same action as realized by the structure of FIGS. 1 and 9 can be realized by a structure of FIGS. 13 and 14. As shown in FIG. 13, optical fibers 303 are laid so as to cover the entire hemispherical surface having the wafer W as the bottom surface and to receive light generated from an illumination region on the wafer W. Then, for example, as shown in FIG. 14, 12 adjoining fibers 303a which constitute each unit is rearranged on the exit side as fibers 303b, which are divided into four fiber bundles 304a-304d each consisting of three arbitrary fibers. Exit beams of the fiber bundles 304a-304d are condensed onto four photodetectors 307 by four lenses 305, respectively. If polarization-maintaining fibers are used as the above detection optical fibers, light generated from an illumination region on the wafer W can be guided to the photodetectors 307 without losing polarization information of the light. Therefore, if polarizing plates 306 are disposed before the respective photodetectors 307, beams coming through approximately the same solid angle range can be detected so as to be divided into four polarization components in the same manner as described above with reference to FIG. 9. For a use that does not require division into plural polarization components, non-polarization-maintaining fibers such as ordinary single-mode fibers or multi-mode fibers may be used.

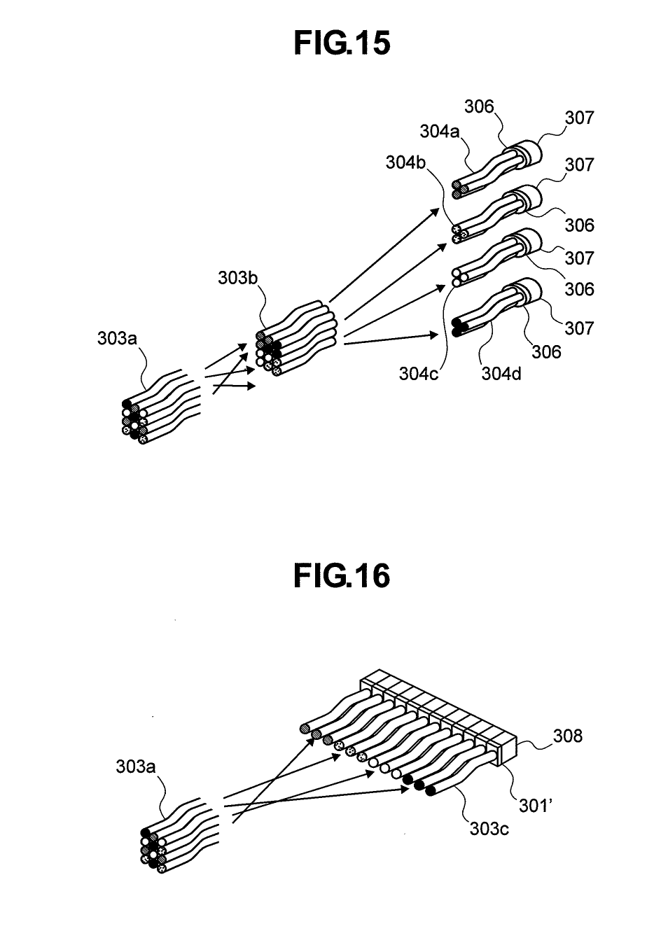

Alternatively, as shown in FIG. 15, the fiber bundles 304a-304d may be connected directly to the respective photodetectors 307 without using lenses. Also in this case, if the polarizing plates 306 are disposed before the respective photodetectors 307, beams coming through approximately the same solid angle range can be detected so as to be divided into four polarization components in the same manner as described above with reference to FIG. 9.

As a further alternative, as shown in FIG. 16, exit beams of fibers 303c may be detected by respective pixels of a line sensor 308 (or a two-dimensional sensor). In this case, if polarizers 301′ are attached to the respective pixels, beams coming through approximately the same solid angle range can be detected so as to be divided into four polarization components in the same manner as described above with reference to FIG. 9.

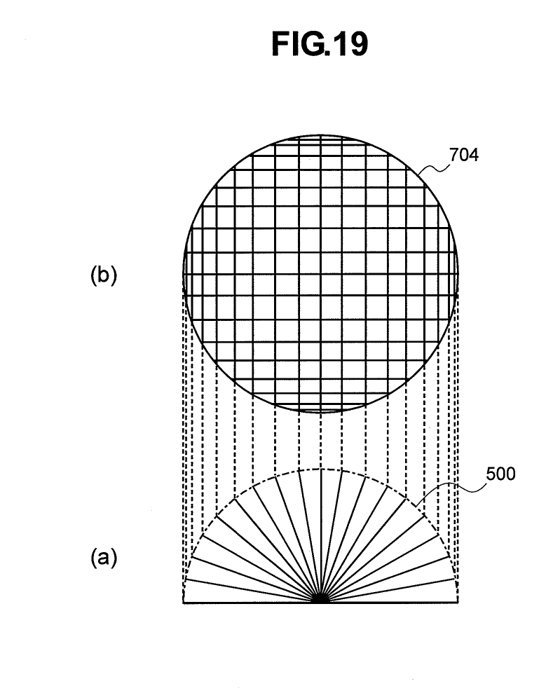

FIG. 19 shows how signals obtained through the hemispherical surface 500 are projected onto a plane (circle) 704. The plane 704 is generally called a pupil. In performing signal processing such as image processing, in many cases a two-dimensional image can be handled more easily when it is expressed by X-Y coordinates than by polar coordinates. Therefore, in this embodiment, signals obtained are processed after being converted into pupil images. This distribution corresponds to a far-field pattern of light generated from an illumination region on the wafer W, and it can be said this distribution is a pattern obtained by Fourier-converting a near-field pattern in the illumination region on the wafer W.

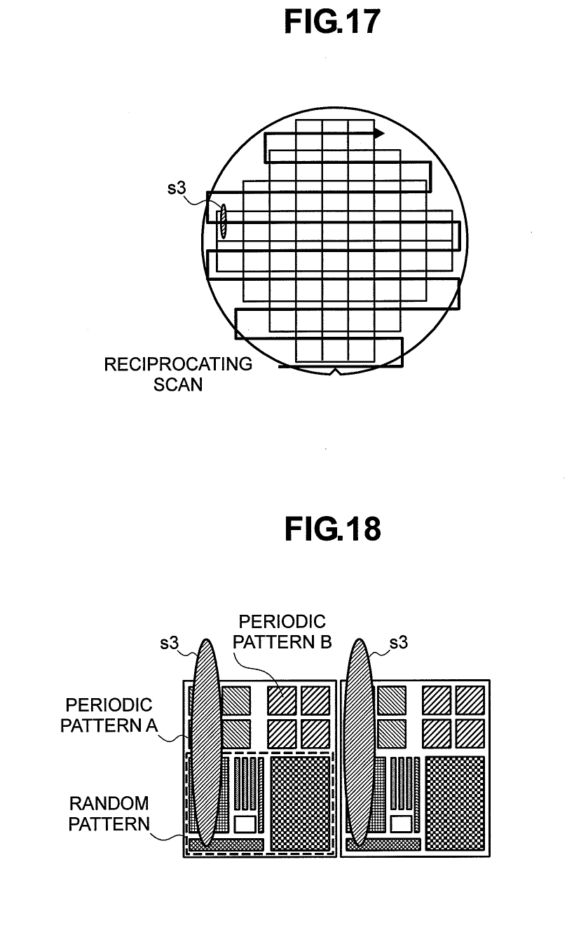

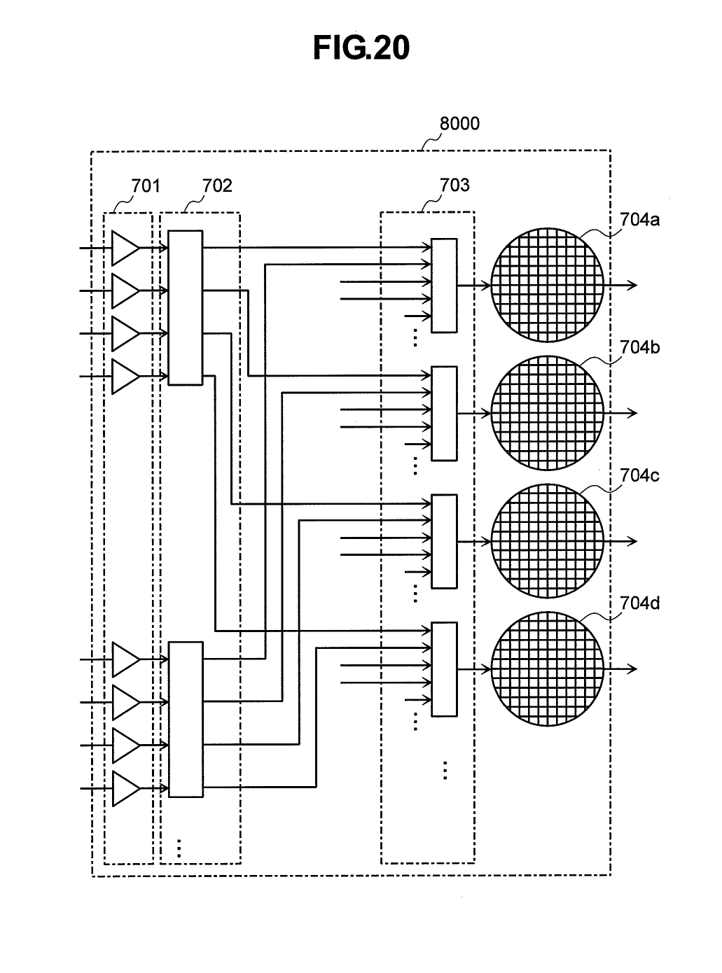

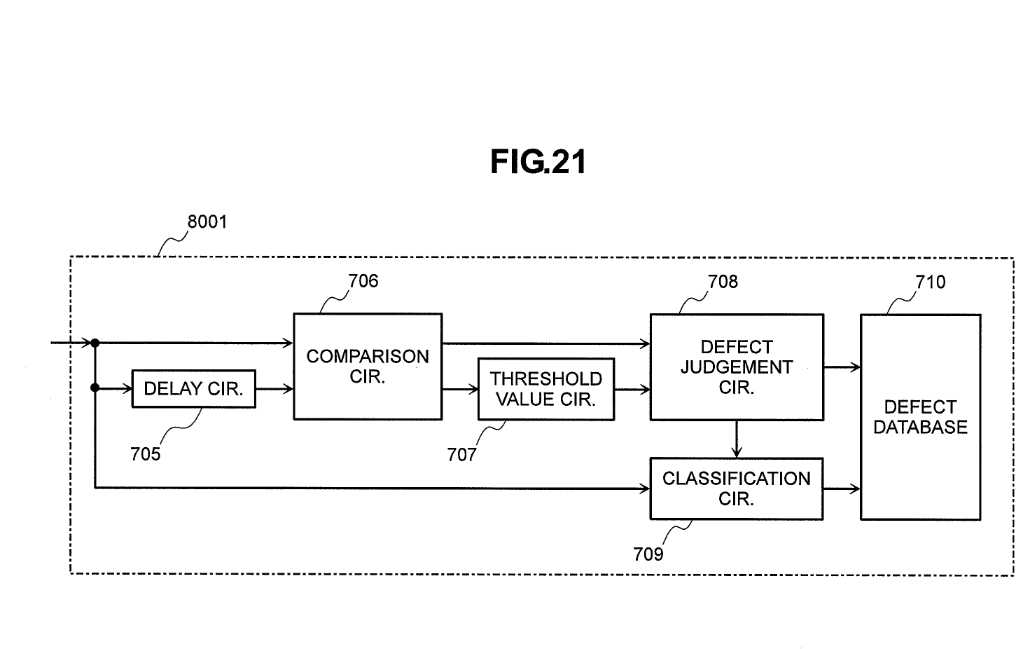

A method for processing electrical signals produced by the 4-segmented photodetectors 302 will be described with reference to FIG. 20. Electrical signals produced by the four elements of each 4-segmented photodetector 302 are sent to the signal processing section 8000. In the signal processing section 8000, the analog electrical signals are amplified by an amplifier 701 and then converted into digital signals (e.g., 8-bit gray scale signals) by an A/D converter 702. Digital signals produced by the different 4-segmented photodetectors 302 and corresponding to the same polarization component are collected, whereby pupil images 704a-704d corresponding to the different polarization components are generated. The wafer W is scanned in a zigzagged manner as shown in FIG. 17, for example. FIG. 18 schematically shows two adjoining chips 1801a and 1801b formed on the wafer W. The chips are illuminated sequentially in such a manner that the illumination region s3 is moved on the wafer W.

Where the wafer W is a wafer having patterns as shown in FIG. 18, a process shown in FIG. 21 is executed. One of the pupil images 704a-704d is input to an image processing section 8001. An inspection image delayed by a delay circuit 705 is compared with a reference image which is a detection result of the same region of an adjacent chip by a comparison circuit 706, whereby defects or foreign substances are detected. For example, a difference image from a detection image of the same region of an adjacent chip is calculated, binarized, and used for determining a binarization threshold value in a threshold value circuit 707. A defect judgment circuit 708 judges that signals that are larger than the binarization threshold value correspond to defects. As for signals that have been judged as corresponding to defects, the defect are classified into plural kinds in a classification circuit 709 on the basis of the detection image. The defect judgment result of the defect judgment circuit 708 and the classification result of the classification circuit 709 are sent to a defect database 710 and recorded there together with defect coordinates. The above processing is performed for each of the pupil images 704a-704d corresponding to the respective polarization components. The results recorded in the defect database 710 are stored in the storage device 7001, output to an external computer, a printer, or an external storage device from the output device 7002, or displayed on the display screen of the display device 7003.

As described above, according to the invention, reflection light, scattered light, or diffraction light generated from an illumination region of an inspection subject being illuminated with the illumination optical system can be detected so as to be divided into plural polarization components through the entire hemispherical surface having the inspection subject as the bottom surface. That is, the NA of the detection optical system can be made close to 1. Although the NA of the detection optical system cannot be made equal to 1 because of implementation-related limitations on the detection optical system, the NA can be made larger than 0.7 by employing the above-described structure.

According to the invention, as shown in FIG. 1, all of light passing through the almost entire hemispherical surface having an inspection subject as the bottom surface is detected for each of different polarization components and converted into electrical signals, which are digitized and stored. Since signals to be used can be selected from the stored digital signals, there does not occur a case that necessary information is lost. This facilitates the discrimination between noise and defects and increases the detection sensitivity of defects occurring on the inspection subject. Furthermore, since defect judgment is performed by using all of plural kinds of polarization-related information obtained for plural detection polarization components, the amount of information is increased and defects can be discriminated from noise with even higher sensitivity.

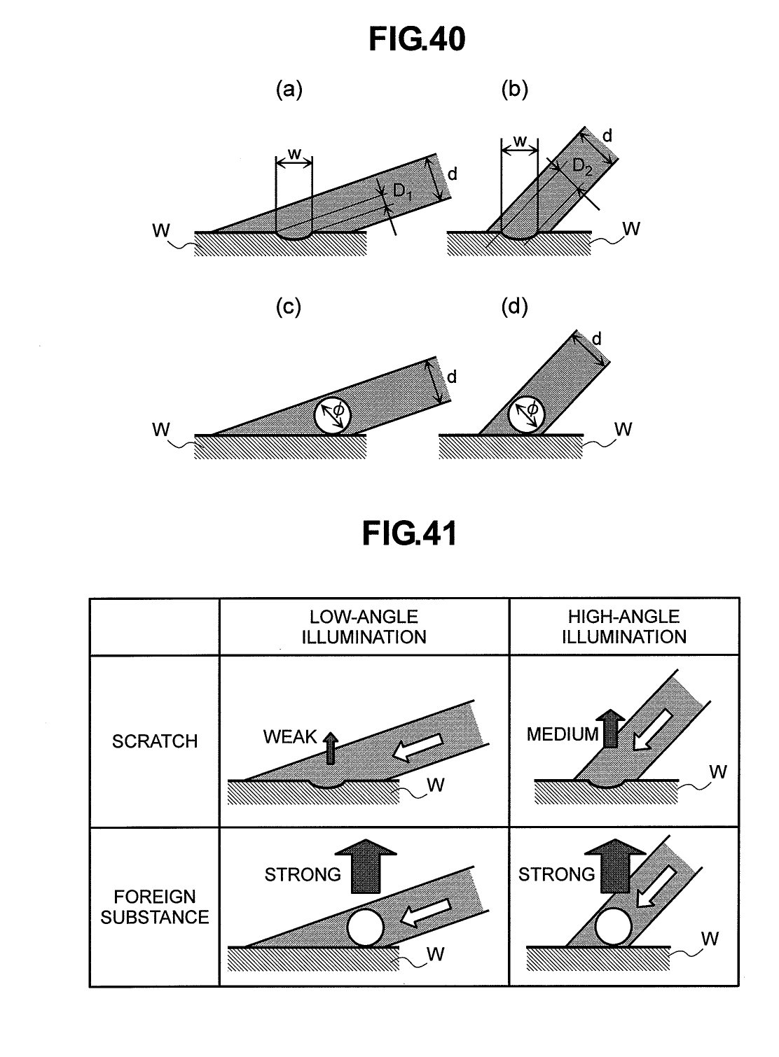

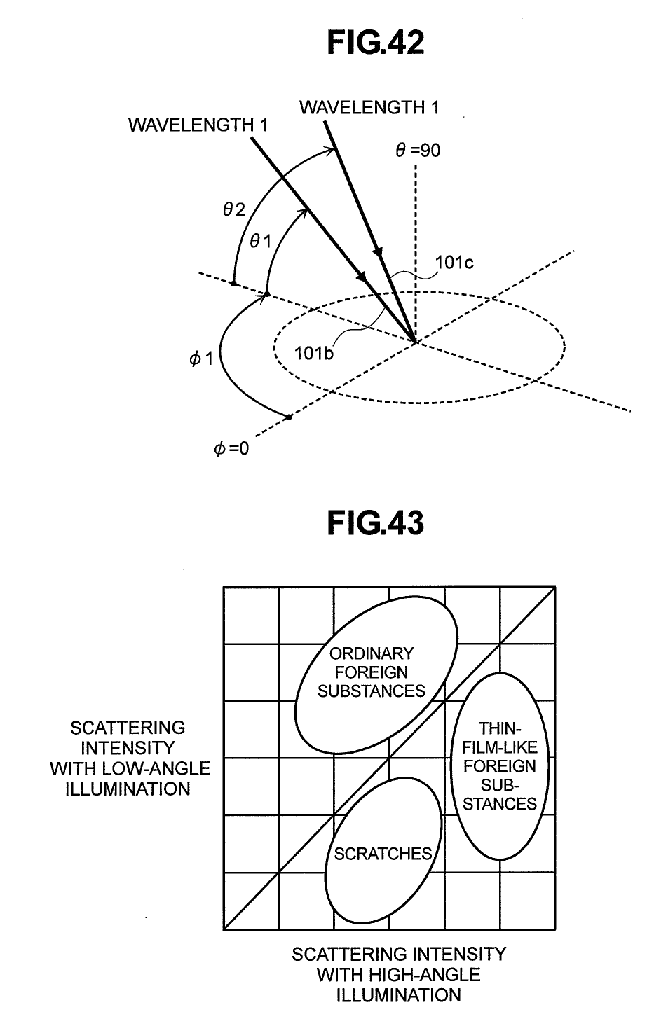

Next, other advantages of the invention will be described with reference to FIGS. 40(a)-40(d) to FIG. 43. FIGS. 40(a)-40(d) show scattering cross sections in cases that a recess defect (e.g., scratch) and a projection defect (e.g., foreign substance) on a wafer W are illuminated with light at different elevation angles. More specifically, FIG. 40(a) shows a case that a recess defect is illuminated from a direction having a small elevation angle (i.e., having a large angle with respect to the normal to the surface of a wafer W). FIG. 40(b) shows a case that a recess defect is illuminated from a direction having a large elevation angle (i.e., having a small angle with respect to the normal to the surface of a wafer W). FIG. 40(c) shows a case that a projection defect is illuminated from a direction having a small elevation angle (i.e., having a large angle with respect to the normal to the surface of a wafer W) FIG. 40(b) shows a case that a projection defect is illuminated from a direction having a large elevation angle (i.e., having a small angle with respect to the normal to the surface of a wafer W).

Where a scratch is illuminated with a beam whose beam diameter d is larger than the size of the scratch, the scattering cross section (net illumination area) decreases from w×D₂ to w×D₁ when the illumination elevation angle is decreased. On the other hand, in the case of a foreign substance, the scattering cross section is kept approximately constant at π×(φ/2)² independently of the illumination elevation angle. Therefore, as shown in FIG. 41, whereas the scattering intensity of a scratch is lower in the case of low-angle illumination than in the case of high-angle illumination, the scattering intensity of a foreign substance in the case of low-angle illumination is approximately equal to that in the case of high-angle illumination. Therefore, defects can be classified into ordinary foreign substances, scratches, thin-film-like foreign substances, etc. by calculating the ratio between two kinds of scattering intensity (see FIG. 43) using signals obtained by illuminating the wafer W with beams 101b and 101c having the same wavelength that are applied at the same azimuth angle φ1 and different elevation angles θ1 and θ2 (see FIG. 42).

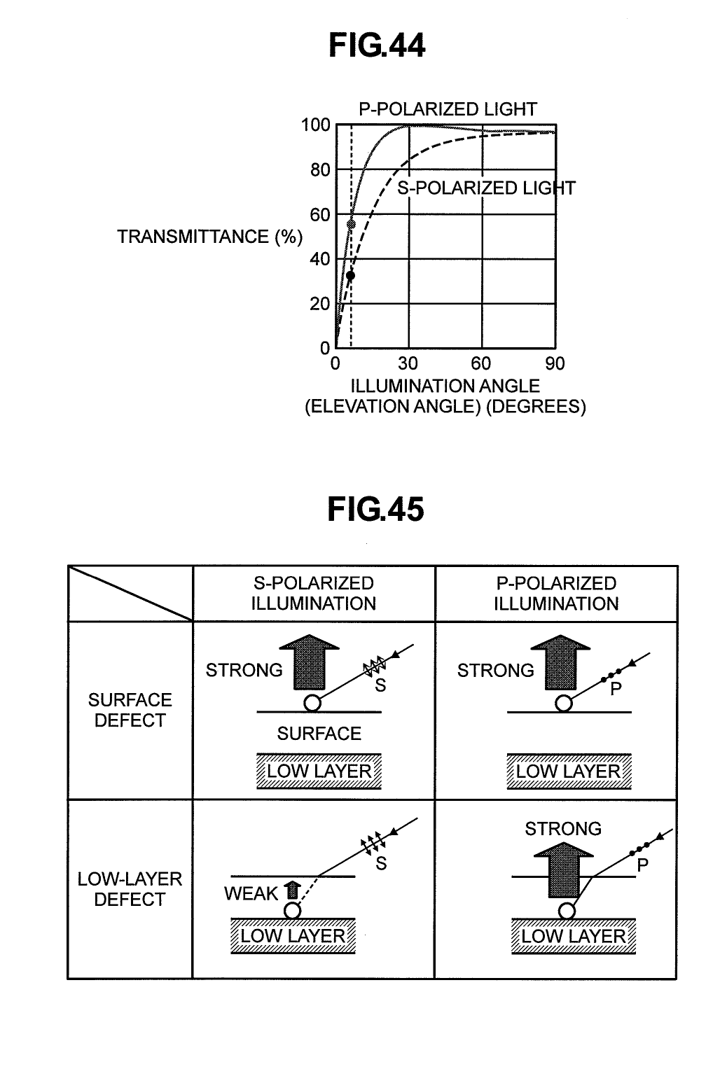

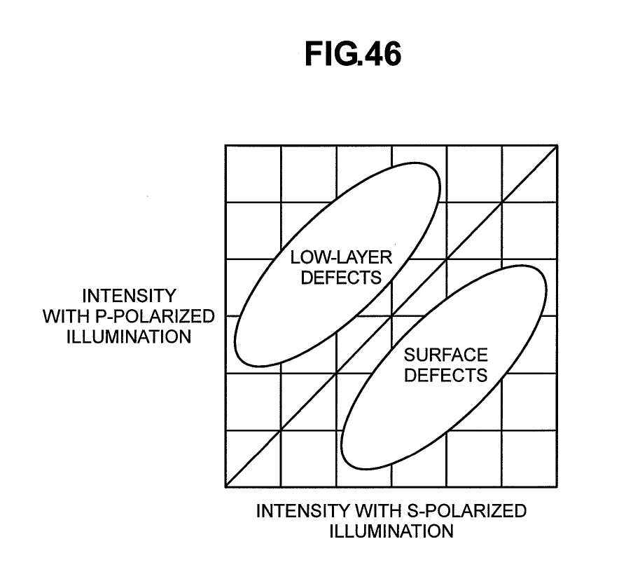

As shown in FIG. 44, even if the illumination angle is the same, the transmittance depends on the polarization (p-polarization or s-polarization). More specifically, as shown in FIG. 45, in the case of s-polarization, the scattering intensity is lower when a defect is located inside the transparent film than when a defect is located on top of a transparent film. In contrast, in the case of p-polarization, there is no large difference in scattering intensity between these two cases. Therefore, as shown in FIG. 46, discrimination can be made between a defect inside a film (low-layer defect) and a defect on a film (surface defect) by calculating the ratio between scattering intensity obtained with s-polarized illumination and that obtained with p-polarized illumination.

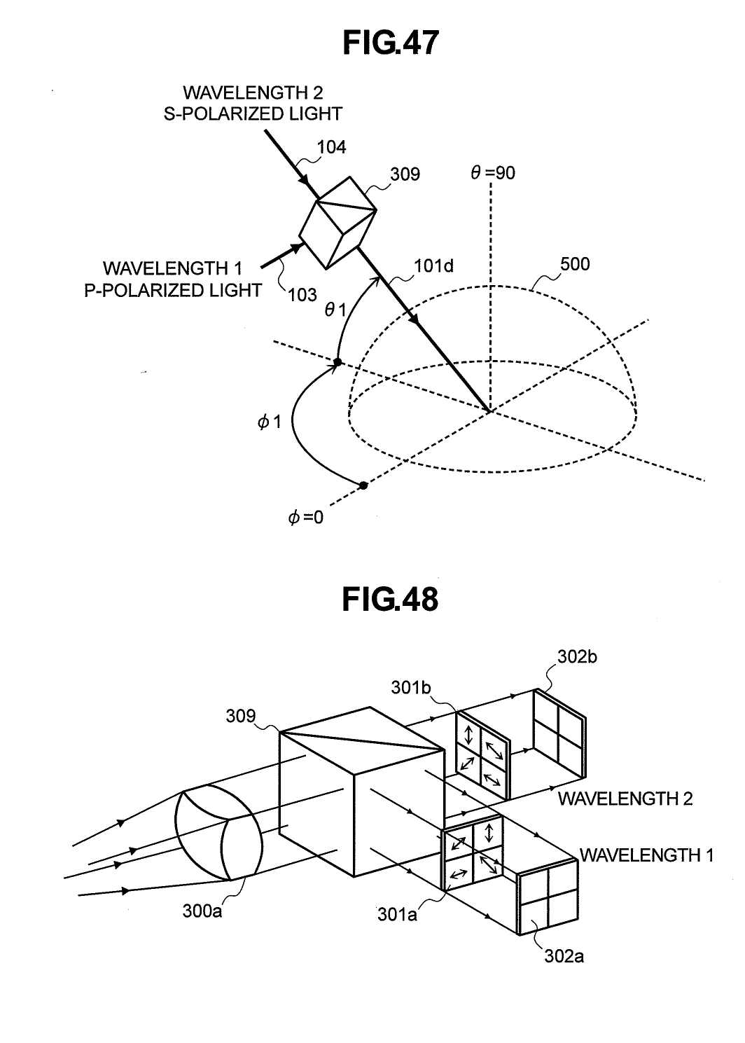

One method for applying two beams having different polarization components is to apply two beams at different time points. However, this method is disadvantageous in that the inspection time is increased. For example, this problem can be solved by the following method. As shown in FIG. 47, an s-polarized beam 104 and a p-polarized beam 103 having different wavelengths are combined by a polarizing beam splitter 309 into a single beam 101d, which is applied to the wafer W at an azimuth angle φ1 and an elevation angle θ1. As shown in FIG. 48, each scattered beam coming from the wafer W is condensed by a condenser lens 300 and polarization-separated by a polarizing beam splitter 309. Each of resulting beams having the respective wavelengths is divided into four polarization components by a 4-segmented polarizing plate 301a or 301b and converted into electrical signals by a 4-segmented photodetector 302a or 302b. In this manner, signals obtained through illumination with differently polarized beams can be detected by a single inspection. Although the number of signal processing circuits of the entire system is increased because of the separation of polarized beams, the basic configuration and operation are the same as in the system described above with reference to FIGS. 1, 20, and 21 and hence will not be described.

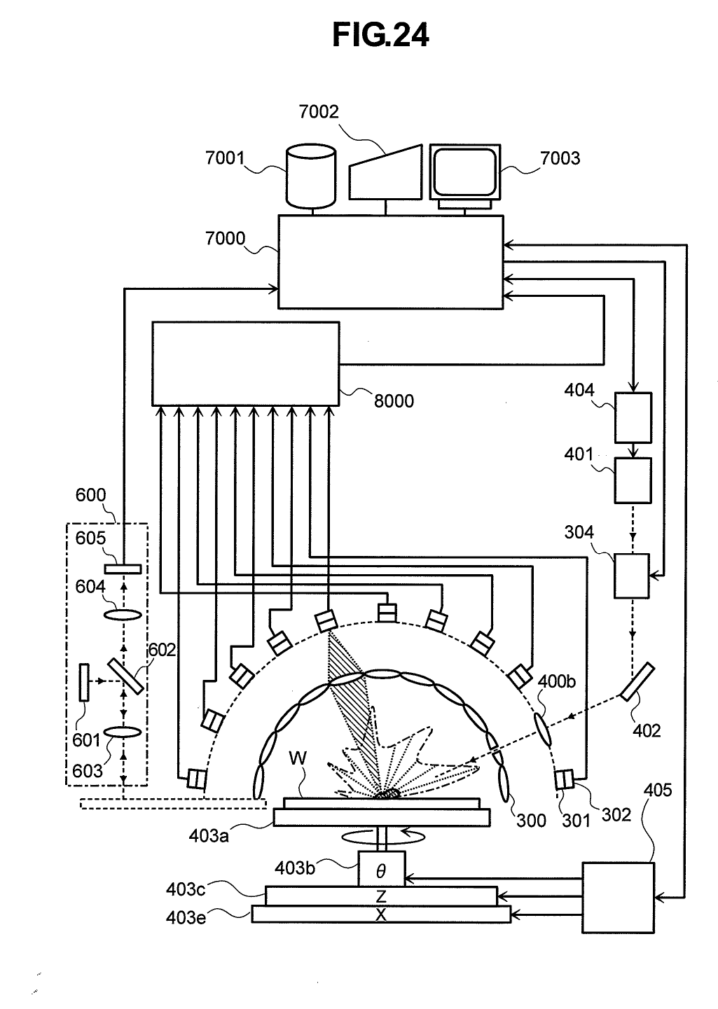

Next, a second embodiment of the invention will be described with reference to FIGS. 24-39. In this embodiment, an inspection subject under inspection is r-θ-scanned by means of the θ stage 403b and the X stage 403e instead of being X-Y-scanned. The other part of the configuration and the other functions are the same as in the first embodiment and hence will not be described.

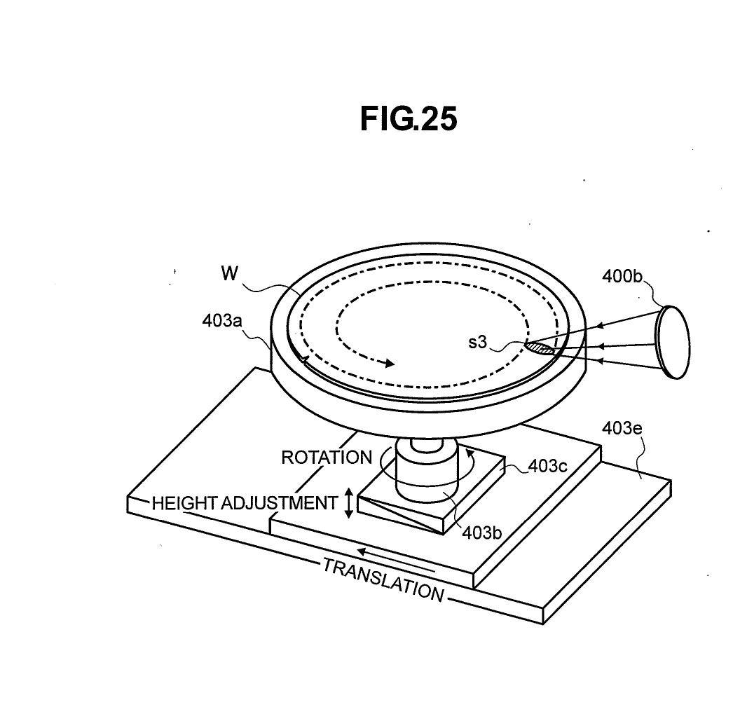

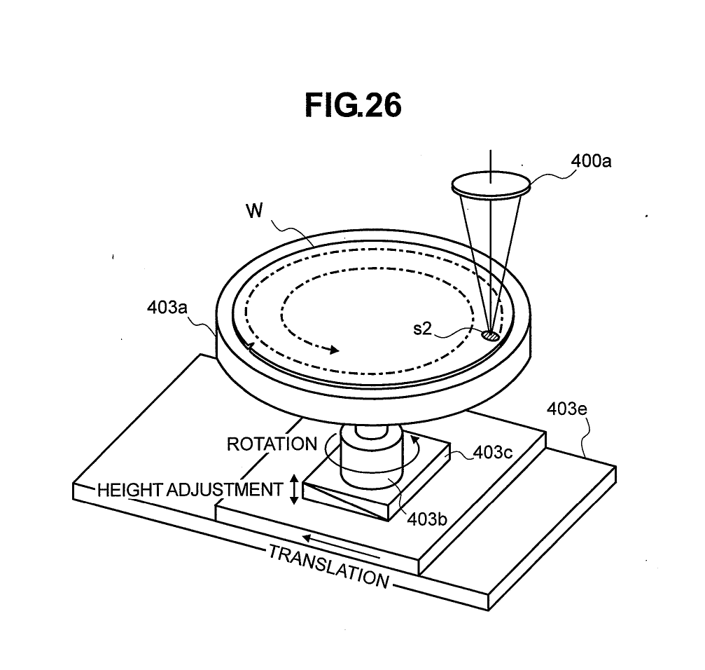

As shown in FIGS. 25 and 26, the illumination optical system is configured so as to illuminate a wafer W with light using the lens 400a or 400b and other elements. The illumination optical system is adjusted so that the wafer W is located at the focal position of the cylindrical lens 400a or the spherical lens 400b. The illumination can be performed from an arbitrary direction that is determined by an arbitrary azimuth angle φ1 and an arbitrary elevation angle θ1 in the same manner as described in the first embodiment with reference to FIG. 4. The illumination region may be circular or linear. Where illumination with a small spot size is desired, employment of epi-illumination is proper because it can prevent elongation of a spot on the wafer W. As for the other points of the manners of illumination and detection, only points that are different than in the first embodiment of the invention will be described.

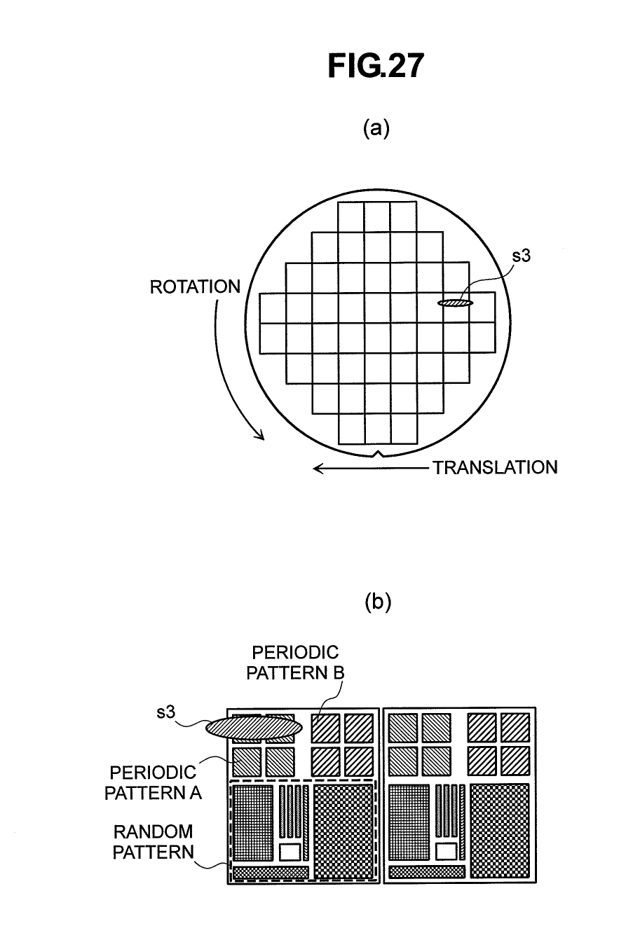

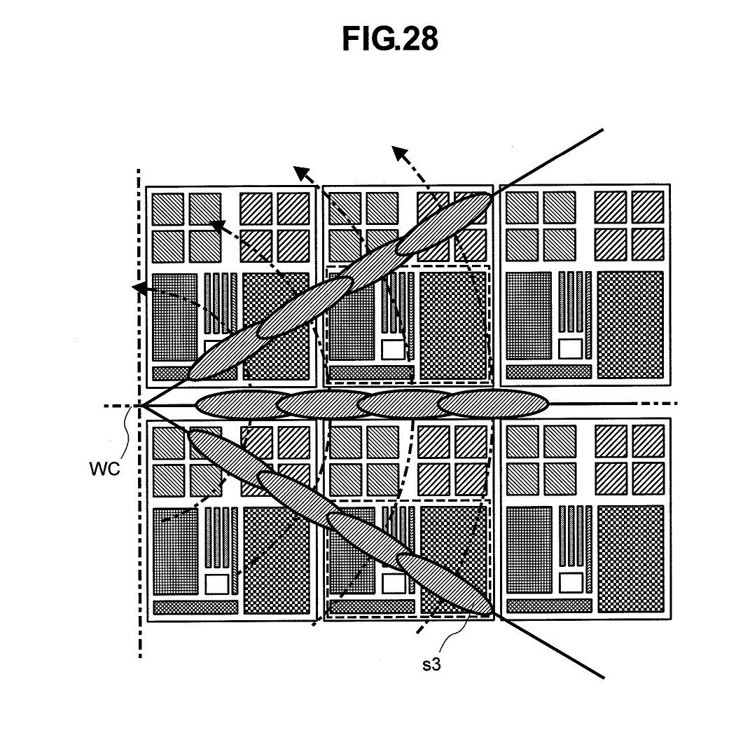

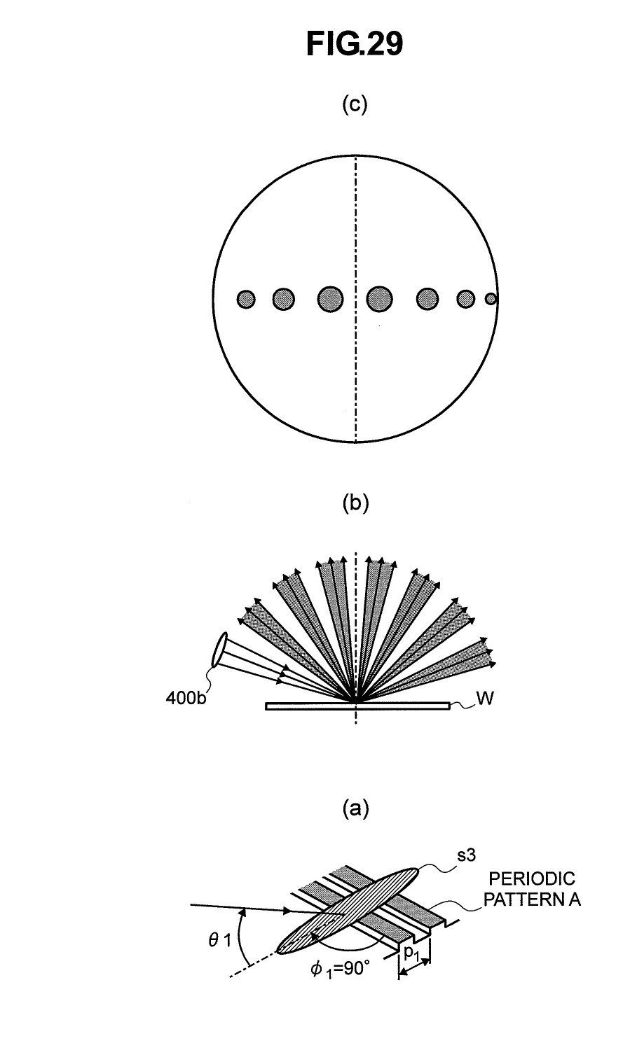

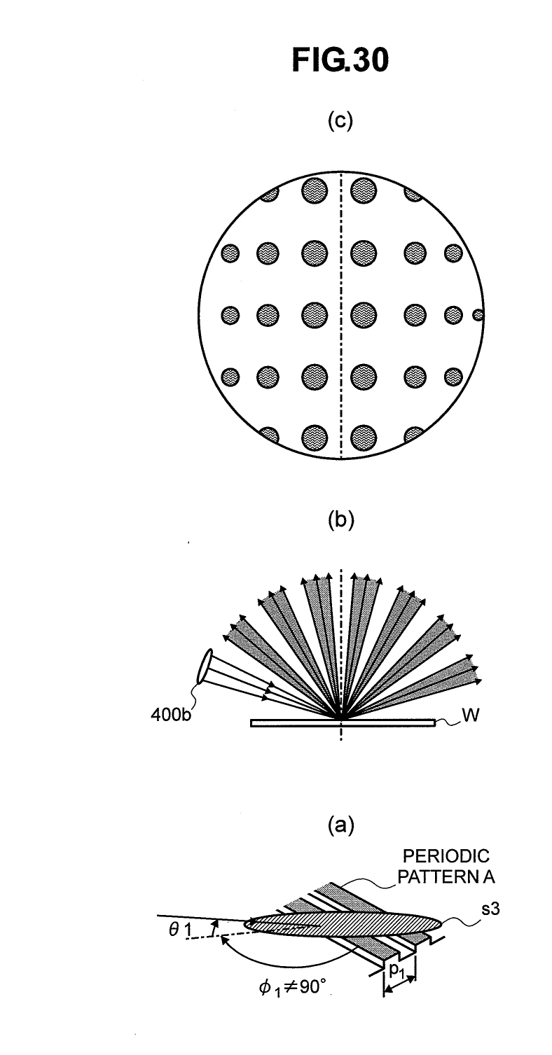

FIG. 27(a) shows the wafer W under inspection and an illumination region s3 at a certain time point, and FIG. 27(b) is an enlarged view of part of the surface of the wafer W. FIG. 28 shows the positions of illumination regions s3 on the wafer W at plural time points. Although actually the wafer W is rotated, to facilitate illustration of relative movement between the wafer W and the illumination region s3, FIG. 28 is drawn as if the illumination region s3 moved on the wafer W. In the case of rotational scanning, to make the illumination energy applied to the wafer W constant, it is desirable to set the circumferential speed constant. However, in the rotational scanning, as shown in FIG. 28, the same regions of different chips on the wafer W are not necessarily illuminated in the same direction even if the circumferential speed is set constant. FIGS. 29(a)-29(c) and FIGS. 30(a)-30(c) show a case that the same regions of different chips on the wafer W are illuminated from different illumination directions (FIG. 29(a) shows a state that a periodic pattern on the wafer W is illuminated from a direction that is perpendicular to it (φ1=90°) and FIG. 30(a) shows a state that the periodic pattern on the wafer W is illuminated from a direction that is oblique to it (φ1≠90°)). In this case, diffraction beams generated by the patterns have different distributions (see FIGS. 29(b) and 30(b)) and diffraction light patterns at the pupil position have different distributions (see FIGS. 29(c) and 30(c)). As a result, the application of the die-to-die comparison or the chip comparison becomes more complex than in the first embodiment.

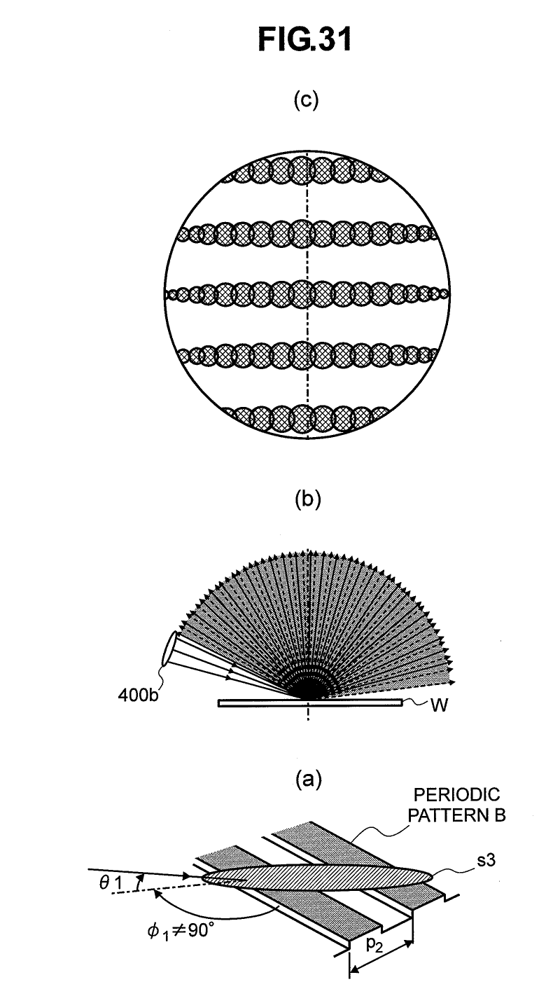

In view of the above, in the second embodiment, signals obtained are processed in the following manner. For example, assume that, as shown in FIGS. 30(a) and 31(a), illumination beams are applied to two patterns having different pattern pitches p1 and p2 at the same azimuth angle and elevation angle. In this case, generated diffraction beams have different pitches as shown in FIGS. 30(b) and 31(b). The distributions of diffraction beams at the pupil position are different from each other accordingly as shown in FIGS. 30(c) and 31(c). In the case of FIG. 29(a), the pattern pitch p1 is the same as in the case of FIG. 30(a) but the illumination light is applied at the different azimuth angle than in the case of FIG. 30(a) (φ1=90° in the case of FIG. 29(a) and φ1≠90° in the case of FIG. 30(a)). The distribution of diffraction beams at the pupil position shown in FIG. 29(c) is different from that shown in each of FIGS. 30(c) and 31(c). However, the pitch of the distribution of diffraction beams at the pupil position is determined uniquely by the pattern pitch, the illumination azimuth angle and elevation angle, the illumination wavelength, and the illumination NA.

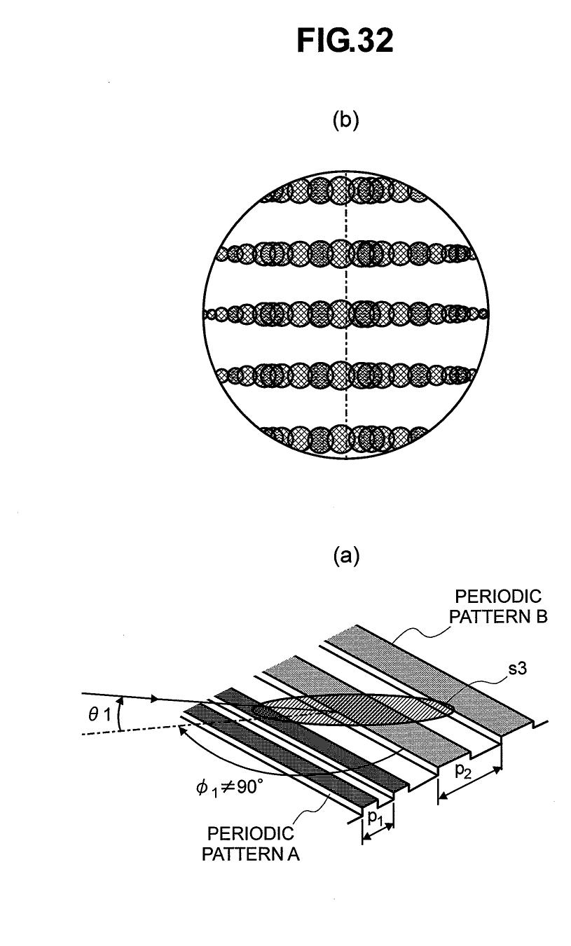

FIG. 32(a) shows another case that the patterns having different pitches p1 and p2 are illuminated simultaneously. In this case, as shown in FIG. 32(b), the distribution of diffraction beams at the pupil position is a superimposition of the distributions of FIGS. 30(c) and 31(c).

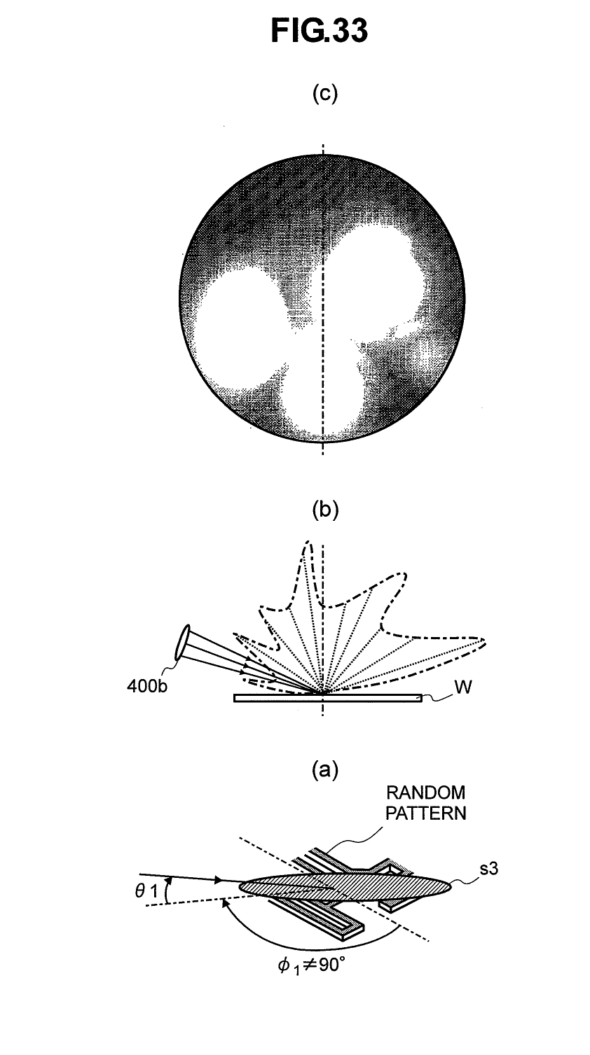

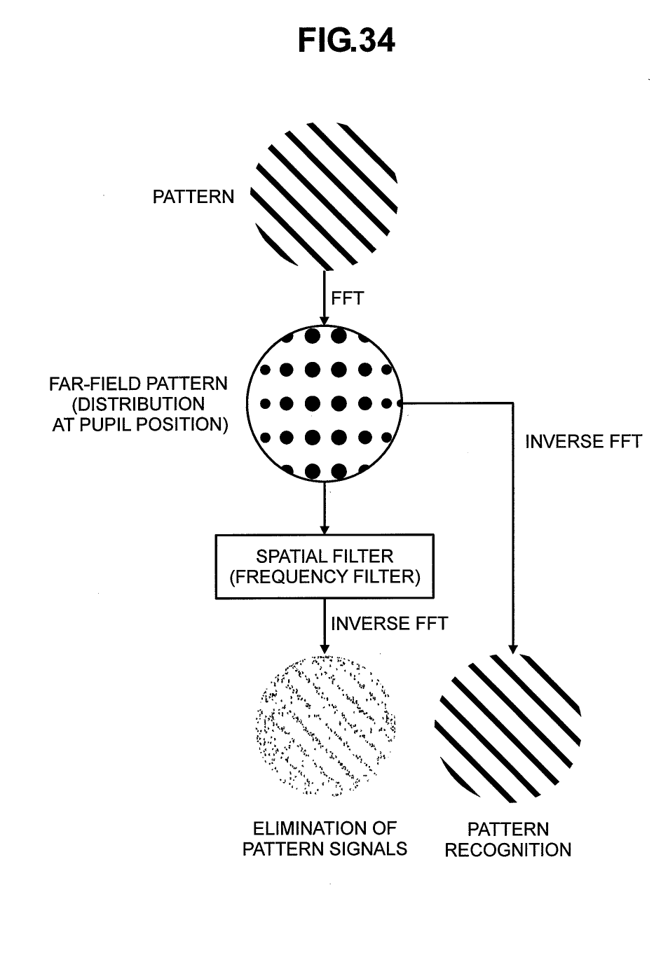

On the other hand, when a random pattern having no regularities is illuminated as shown in FIG. 33(a), diffraction beams generated by the pattern as well as the distribution of the diffraction beams at the pupil position is also random as shown in FIGS. 33(b) and 33(c). As mentioned in the first embodiment of the invention, a distribution at the pupil position is equivalent to a distribution obtained by Fourier-transforming a near-field pattern of a pattern. That is, an original near-field pattern is obtained by inverse-Fourier-transforming a distribution at the pupil position. For example, as shown in FIG. 34, if an original pattern is a periodic pattern, the original pattern can be recognized from an image obtained by inverse-Fourier-transforming a distribution at the pupil position.

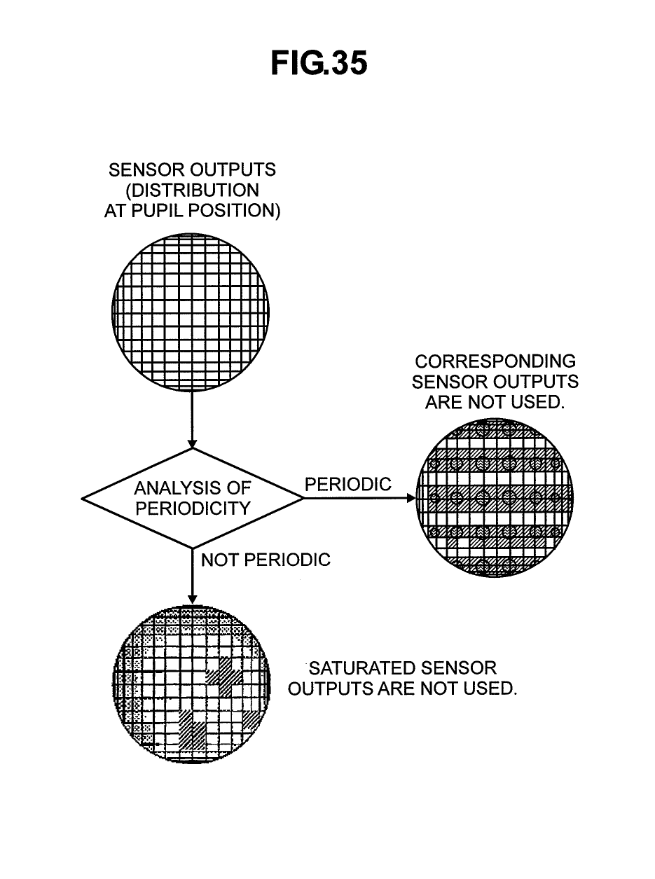

Furthermore, a spatial filtering (i.e., frequency filtering) technique may be introduced in the following manner. Pattern signals can be eliminated by recognizing the periodicity of an original pattern from that of a distribution at the pupil position and performing spatial filtering so as to block beams having a encapsulation frequency corresponding to the original pattern, whereby the defect detection sensitivity can be increased. Specifically, this may be done in a manner shown in FIG. 35. The periodicity of a distribution at the pupil position is analyzed from outputs of all the sensors. If certain periodicity is found, that is, if the original pattern is a periodic pattern, sensor outputs corresponding to periodic signals in the distribution at the pupil position are not used. If no periodicity is found, an exemplary measure is to refrain from using saturated sensor outputs.

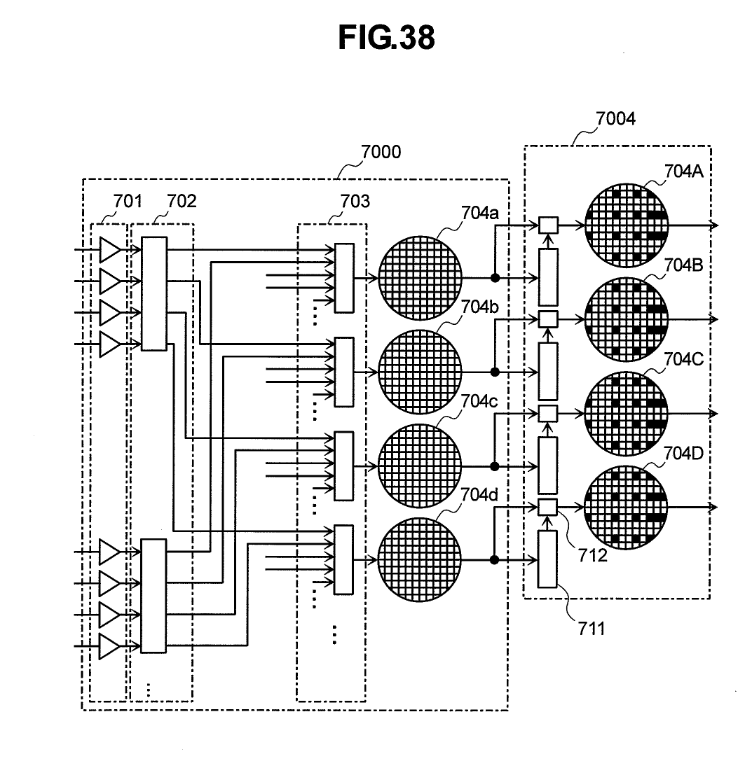

A method for processing outputs of the respective sensors will be described again with reference to FIG. 38. Electrical signals produced by the 4-segmented photodetectors 302 are sent to the signal processing section 8000. In the signal processing section 8000, the analog electrical signals are amplified by an amplifier 701 and then converted into digital signals (e.g., 8-bit gray scale signals) by an A/D converter 702. Digital signals produced by the different 4-segmented photodetectors 302 and corresponding to the same polarization component are collected by an altered image generation circuit 703, whereby pupil images 704a-704d corresponding to the different polarization components are generated. The pupil images 704a-704d are sent to a signal selection circuit 7004. In the signal selection circuit 7004, the periodicity of a distribution at the pupil position is analyzed by each periodicity judgment circuit 711 and signals to be used are selected by each signal selection circuit 712. As a result, signal-selected pupil images 704A-704D are obtained from the pupil images 704a-704d. The signal-selected pupil images 704A-704D are pattern-information-eliminated pupil images.

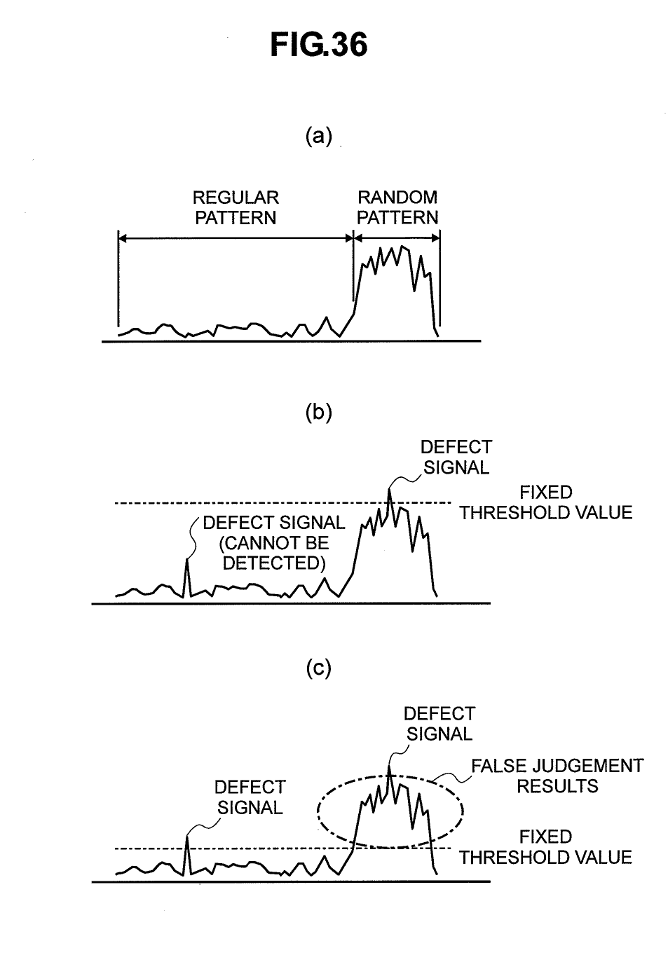

Next, a method for detecting defects will be described. FIG. 36(a) shows a temporal variation of an addition result of all signals of a single signal-selected pupil image. If the pattern is periodic, almost no light is incident on the sensors used and hence the signal level is low. On the other hand, if the pattern is random, the signal level is generally high. In this case, even if defect signals exist as shown in FIG. 36(b), the defect in the periodic pattern area cannot be detected if a threshold value is set for signal levels corresponding to the random pattern area. On the other hand, if a threshold value is set for signal levels corresponding to the periodic pattern area as shown in FIG. 36(c), false judgment results are produced so as to correspond to the random pattern area. In view of the above, in this embodiment, a threshold value is set in the following manner.

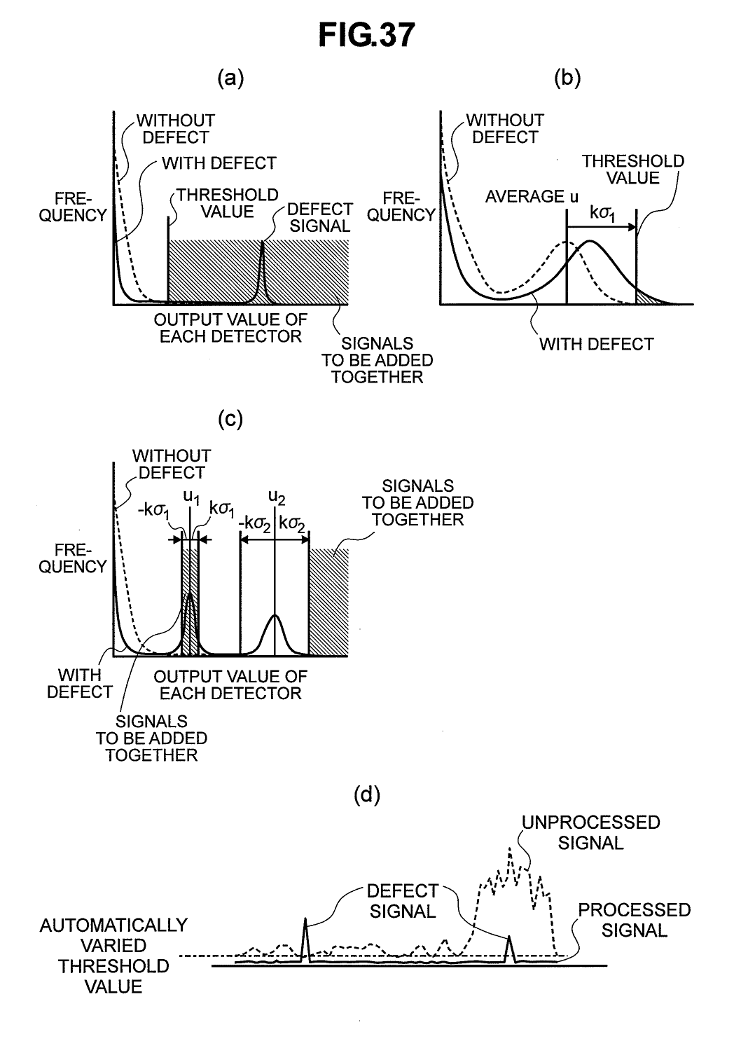

FIG. 37(a) is a graph for a periodic pattern. A broken line represents a frequency distribution of sensor output values in the case where no defect exists. Since no light is incident on almost all the sensors, signals are concentrated in a low-level range. If a defect exists, signals are concentrated in a restricted, large output value range (represented by a solid line). In many cases, such a distribution is a Gaussian distribution. In view of the above, a threshold value is set in advance to a lowest value of signal levels used and only signals whose levels are higher than the threshold value are added together.

FIG. 37(b) is a graph for a random pattern. A broken line represents a frequency distribution of sensor output values in the case where no defect exists. Since light is incident on almost all the sensors, signals are concentrated in a high-level range. It is considered that the curve is shifted to the high-level side as a whole (represented by a solid line) if a defect exists. In many cases, such a distribution is also a Gaussian distribution. In view of the above, an average u and a variance σ of a Gaussian distribution are determined and u+k×σ is calculated by using a coefficient k which is set separately. Since differences between signals with a defect and signals without a defect appear in signals above u+k×σ, this value is employed as a threshold value and only the signals whose levels are higher than the threshold value are added together.

Where a periodic pattern and a random pattern exist in mixture, it is appropriate to handle the pattern as a random pattern. Alternatively, in the case where as shown in FIG. 37(c) a distribution specific to a regular pattern is found in a distribution specific to a random pattern, an average u₁ and a variance σ₁ are determined for the distribution specific to a regular pattern and signals in a range of u₁−k×σ₁ to u₁+k×σ₁ are added together. Furthermore, an average u₂ and a variance σ₂ are determined for the distribution specific to a random pattern and signals whose levels are higher than u₂+k×σ₂ are added together. In this case, as shown in FIG. 37(d), an addition result of output values is small if no defect exists and the signal level increases only when a defect exists. Therefore, a threshold value can be set as if it were varied automatically. A defect can thus be detected stably.

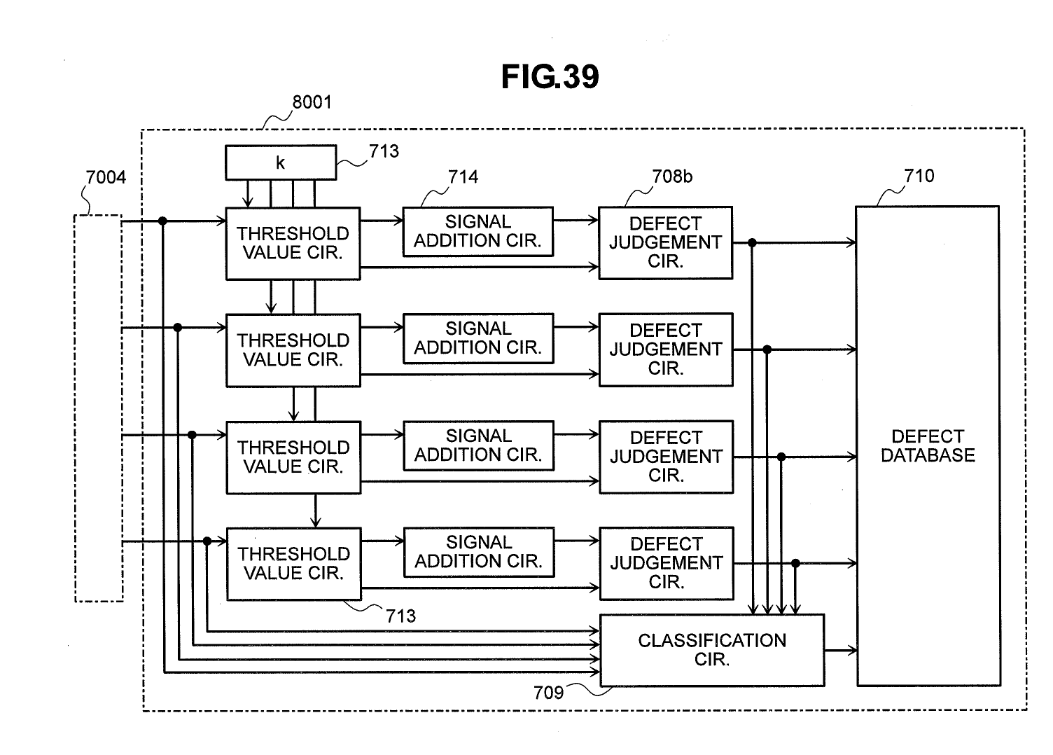

FIG. 39 shows a specific circuit configuration. Signal-selected pupil images are sent to an image processing section 8001, where threshold values are determined as appropriate by threshold circuits 713. Then, the signals are added together by signal addition circuits 714 and addition results are compared with the threshold values by defect judgment circuits 708b, whereby defects are detected. The defects thus detected are classified into several kinds and subjected to size calculation in a classification circuit 709. The classification is performed using signals that have not been subjected to threshold value processing. Although in FIG. 39 the image processing section 8001 uses signals that have not been subjected to threshold value processing, it may use signals that have been subjected to threshold value processing. The defect judgment results of the defect judgment circuits 708b and the classification result of the classification circuit 709 are sent to a defect database 710 and recorded there together with defect coordinates. The above processing is performed for the pupil images corresponding to the respective polarization components. The results recorded in the defect database 710 are stored in the storage device 7001, output to an external computer, a printer, or an external storage device from the output device 7002, or displayed on the display screen of the display device 7003.

As described above, according to the invention, reflection light, scattered light, or diffraction light generated from an illumination region of an inspection subject being illuminated with the illumination optical system can be detected so as to be divided into plural polarization components through the entire hemispherical surface having the inspection subject as the bottom surface.

As shown in FIG. 49, in the conventional technique, only part of light passing through the hemispherical surface having an inspection subject as the bottom surface is detected in detecting light optically. Therefore, when it becomes necessary to use light passing through a non-detection region, such work as changing the apparatus configuration is necessary. That is, as shown in FIG. 50, optical filtering is performed before the photoelectric conversion and part of the information is thereby lost.

According to the invention, as shown in FIG. 24, signals to be used can be selected after light passing through the almost entire hemispherical surface having an inspection subject as the bottom surface is detected for each of different polarization components and converted into electrical signals. Therefore, necessary information can be used without being lost. This facilitates the discrimination between noise and defects and increase the detection sensitivity of defects occurring on the inspection subject. Die-to-die comparison or chip comparison is not necessary, and optimum spatial filtering can be performed by recognizing a pattern during an inspection. Furthermore, threshold values can be determined automatically from signals obtained, which increases the detection sensitivity to a very large extent.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A defect detecting apparatus comprising:
a stage for moving an inspection subject in a plane in a state that the inspection subject is mounted thereon;
a light source;
illumination optical system means for illuminating the inspection subject mounted on the stage with light emitted from the light source;
detection optical system means in which plural condensing members for condensing reflection light, scattered light, or diffraction light coming from the inspection subject being illuminated by the illumination optical system means are arranged hemispherically with respect to the inspection subject;
polarization separating means disposed so as to correspond to the respective condensing members of the detection optical system means, each for separating condensed light produced by the corresponding condensing member into plural polarization components;
detecting means each for detecting and photoelectrically converting the plural polarization components produced by the corresponding polarization separating means;
signal processing means for processing electrical signals produced by the detecting means;
defect detecting means for detecting defects from signals produced by the signal processing means;
defect classifying means for judging positions, kinds, and sizes of the defects detected by the defect detecting means, using their signals;
defect information output means for outputting defect information obtained by the defect classifying means to the outside; and
storing means for storing the defect information obtained by the defect classifying means.

2. The defect detecting apparatus according to claim 1, wherein the light source is a laser light source.

3. The defect detecting apparatus according to claim 1, wherein the light emitted from the light source is applied to the inspection subject from a direction that is oblique to the inspection subject.

4. The defect detecting apparatus according to claim 1, wherein beams emitted from the light source are applied to the same region of the inspection subject simultaneously from plural directions.

5. The defect detecting apparatus according to claim 1, wherein the detection optical system means condenses the reflection light, scattered light, or diffraction light coming from the inspection subject with its numerical aperture being in a range of 0.7 to 1.0.

6. The defect detecting apparatus according to claim 1, wherein the detection optical system means is configured in such a manner that plural condenser lenses are arranged in a hemispherical surface having the inspection subject as a bottom surface.

7. A defect detecting apparatus comprising:
a stage for moving an inspection subject in a plane in a state that the inspection subject is mounted thereon;
a light source;
illumination optical system means for illuminating the inspection subject mounted on the stage with light emitted from the light source;
detection optical system means in which plural condensing members for condensing reflection light, scattered light, or diffraction light coming from the inspection subject being illuminated by the illumination optical system means are arranged hemispherically with respect to the inspection subject;
polarization separating means disposed so as to correspond to the respective condensing members of the detection optical system means, each for separating condensed light produced by the corresponding condensing member into plural polarization components;
detecting means each for detecting and photoelectrically converting the plural polarization components produced by the corresponding polarization separating means;
signal processing means for processing electrical signals produced by the detecting means;
defect detecting means for detecting defects from signals obtained by detecting pattern periodicity in signals produced by the signal processing means, selecting detector outputs to be used according to the detected pattern periodicity, extracting signals relating to defect signals from the selected detector outputs, and adding the extracted signals together;
defect classifying means for judging positions, kinds, and sizes of the defects detected by the defect detecting means, using their signals;
defect information output means for outputting defect information obtained by the defect classifying means to the outside; and
storing means for storing the defect information obtained by the defect classifying means.

8. The defect detecting apparatus according to claim 7, wherein the light source is a laser light source.

9. The defect detecting apparatus according to claim 7, wherein the light emitted from the light source is applied to the inspection subject from a direction that is oblique to the inspection subject.

10. The defect detecting apparatus according to claim 7, wherein beams emitted from the light source are applied to the same region of the inspection subject simultaneously from plural directions.

11. The defect detecting apparatus according to claim 7, wherein the detection optical system means condenses the reflection light, scattered light, or diffraction light coming from the inspection subject with its numerical aperture being in a range of 0.7 to 1.0.

12. The defect detecting apparatus according to claim 7, wherein the detection optical system means is configured in such a manner that plural condenser lenses are arranged in a hemispherical surface having the inspection subject as a bottom surface.

13. A defect detecting method comprising the steps of:
illuminating an inspection subject mounted on a stage with light emitted from a light source;
condensing reflection light, scattered light, or diffraction light generated by the inspection subject because of the illumination with plural condensing optical systems that are arranged hemispherically with respect to the inspection subject;
separating each of condensed beams produced by the respective condensing optical systems into plural polarization components;
detecting and photoelectrically converting the plural polarization components;
detecting defects by processing signals produced through the photoelectric conversion;
judging positions, kinds, and sizes of the detected defects; and
outputting information relating to the detected defects.

14. The defect detecting method according to claim 13, wherein the light source emits laser light which is applied to the inspection subject from a direction that is oblique to the inspection subject.

15. The defect detecting method according to claim 13, wherein the light source emits laser light which is applied to the same region of the inspection subject simultaneously from plural directions.

16. The defect detecting method according to claim 13, wherein the condensing optical systems condense the reflection light, scattered light, or diffraction light coming from the inspection subject with their numerical aperture being in a range of 0.7 to 1.0.

17. A defect detecting method comprising the steps of:
illuminating an inspection subject mounted on a stage with light emitted from a light source;
condensing reflection light, scattered light, or diffraction light generated by the inspection subject because of the illumination with plural condensing optical systems that are arranged hemispherically with respect to the inspection subject;
separating each of condensed beams produced by the respective condensing optical systems into plural polarization components;
detecting and photoelectrically converting the plural polarization components;
detecting pattern periodicity by processing electrical signals produced through the photoelectric conversion;
selecting detector outputs to be used according to the detected pattern periodicity;
extracting signals relating to defect signals from the selected detector outputs, and adding the extracted signals together;
detecting defects from signals produced by the addition; and
outputting information relating to the detected defects.

18. The defect detecting method according to claim 17, wherein the light source emits laser light which is applied to the inspection subject from a direction that is oblique to the inspection subject.

19. The defect detecting method according to claim 17, wherein the light source emits laser light which is applied to the same region of the inspection subject simultaneously from plural directions.

20. The defect detecting method according to claim 17, wherein the condensing optical systems condense the reflection light, scattered light, or diffraction light coming from the inspection subject with their numerical aperture being in a range of 0.7 to 1.0.
